(19) United States
(12) Patent Application Publication
(10) Pub. No.: US 2011/0001855 A1
(43) Pub. Date: Jan. 6, 2011

(54) IMAGE SENSOR

(75) Inventor: Shohei MATSUOKA, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/827,488

(22) Filed: Jun. 30, 2010

(30) Foreign Application Priority Data
Jul. 1, 2009 (JP) 2009-157236
Jun. 24, 2010 (JP) 2010-144156

(51) Int. Cl. H04N 5/225; H04N 5/335

(52) U.S. Cl. 348/273; 348/340; 348/E05.024; 348/E05.091

(57) ABSTRACT

An imaging sensor comprising a plurality of pixels is provided. The pixels comprise photoelectric converters and optical members. The optical member covers the photoelectric converter. Incident light passes through the optical member. The pixels are arranged in two dimensions on a light-receiving area. First differences are created for the distances between the photoelectric converter and a far-side surface of the optical member in two of the pixels in a part of pixel pairs among all of the pixel pairs. The far-side surface is an opposite surface of a near-side surface. The near-side surface of the optical member faces the photoelectric converter. The pixel pair includes two of the pixels selected from the plurality of the pixels.

### BACKGROUND OF THE INVENTION

1. Field of the Invention

The present invention relates to an image sensor that can reduce the influence of a ghost image within an entire captured image.

2. Description of the Related Art

Noise referred to as a ghost image is known. A ghost image is generated when an image sensor captures an optical image that passes directly through a imaging optical system as well as a part of the optical image that is reflected between lenses of the optical system before finally reaching the image sensor. A solid-state image sensor that carries out photoelectric conversion for a received optical image and generates an image signal has been recently used for an imaging apparatus. It is known that a ghost image is generated by an image sensor that captures an entire optical image as well as a part of an optical image that has been reflected back and forth between the image sensor and imaging optical system before finally reaching the image sensor again.

Japanese Unexamined Patent Publication No. 2006-332433 discloses a micro-lens array that has many micro lens facing each pixel, and where the micro lenses have fine dimpled surfaces. By forming such micro lenses, the reflection at the surfaces of the micro lenses is decreased and the influence of a ghost image is reduced.

The ghost image generated based on the reflection of light between the lenses of the imaging optical system has a shape similar to a diaphragm, such as a circular or polygonal shape. The ghost image having such a shape is sometimes used as a special photographic effect even though it is noise.

However, the ghost image generated based on the reflection of light between the image sensor and the lens is an image of a repeating pattern of alternating brightness and darkness, because the micro-lens array works as a diffraction grating. Accordingly, the ghost image generated based on the reflection between the image sensor and the lens has a polka-dot pattern.

Such a ghost image of the polka-dot pattern is more unnatural and noticeable than that of the ghost image generated based on the reflection between the lenses. Accordingly, even if the light reflected by the micro lens is lowered according to the above Japanese Unexamined Patent Publication, an entire image still includes an unnatural and noticeable pattern.

### SUMMARY OF THE INVENTION

Therefore, an object of the present invention is to provide an image sensor that can effectively reduce the influence of a ghost image generated by the reflection of an image between an image sensor and the lens.

According to the present invention, an image sensor, comprising a plurality of pixels is provided. The pixels comprise photoelectric converters and optical members. The optical member covers the photoelectric converter. Incident light passes through the optical member. The pixels are arranged in two dimensions on a light-receiving area. First differences are created for the distances between the photoelectric converter and a far-side surface of the optical member in two of the pixels in a portion of pixel pairs among all of the pixel pairs. The far-side surface is an opposite surface of a near-side surface. The near-side surface of the optical member faces the photoelectric converter. The pixel pair includes two of the pixels selected from the plurality of pixels.

According to the present invention, an image sensor, comprising a plurality of pixels is provided. The pixels comprise photoelectric converters and optical members. The optical member covers the photoelectric converter. Light toward the photoelectric converter passes through the optical member. The pixels are arranged in two dimensions on a light-receiving area. First differences are created in the thickness of the optical member between two of the pixels in a portion of pixel pairs among all of the pixel pairs. The pixel pair includes two of the pixels selected from the plurality of the pixels.

According to the present invention, an image sensor, comprising a plurality of pixels is provided. The pixels comprise photoelectric converters and optical members. The optical member covers the photoelectric converter. Incident light passes through the optical member. The pixels are arranged in two dimensions on a light-receiving area. First differences are created for the distances between the photoelectric converter and a near-side surface of the optical member in both of the pixels in a portion of pixel pairs among all of the pixel pairs. The near-side surface of the optical member faces the photoelectric converter. The pixel pair includes two pixels selected from the plurality of pixels.

### BRIEF DESCRIPTION OF THE DRAWINGS

The objects and advantages of the present invention will be better understood from the following description, with reference to the accompanying drawings in which:

FIG. 1 shows a condition where the ghost image is generated based on the reflection between the lenses;

FIG. 2 shows a condition where the ghost image is generated based on the reflection between the image sensor and the lens;

FIG. 3 is a sectional view of the image sensor of the first embodiment;

FIG. 4A is a sectional view of the image sensor of the first embodiment showing the variation of the diffraction angle;

FIG. 4B is a sectional view of the image sensor of the first embodiment showing the reflection of light at the external surface of the micro-lens array;

FIG. 4C is a sectional view of the image sensor of the first embodiment showing the reflection of light at the internal surface of the micro-lens array;

FIG. 5 is a sectional view of the image sensor of the first embodiment for explanation of the external and internal optical path length in the first embodiment;

FIG. 6 is a polka-dot pattern of the ghost image generated by various image sensors;

FIG. 7 is a plane view of a part of the image sensor;

FIG. 8 is a polka-dot pattern of the r-d-ghost image for different colored light;

FIG. 9 shows the directions of diffraction light generated between two neighboring pixels;

FIG. 10 shows the relation between the arrangement of the lengthened pixels and the normal pixels, and the in-r-difference between pairs of two pixels;

FIG. 11 shows positions of neighboring pixels, first and second next-neighboring pixels against a target pixel;

FIG. 12 is a deployment diagram regarding pixels showing the arrangement of pixels on the image sensor of the first embodiment;

FIG. 13 is an in-r-difference indication diagram showing the existence of the in-r-difference between each of pixels and a neighboring pixel in the first embodiment;

FIG. 14 is an in-r-difference indication diagram showing the existence of the in-r-difference between each of pixels and a first next-neighboring pixel in the first embodiment;

FIG. 15 is an in-r-difference indication diagram showing the existence of the in-r-difference between each of pixels and a second next-neighboring pixel in the first embodiment;

FIG. 16 is a deployment diagram regarding pixels showing the arrangement of pixels on the image sensor of the second embodiment;

FIG. 17 is an in-r-difference indication diagram showing the existence of the in-r-difference between each of pixels and a neighboring pixel in the second embodiment;

FIG. 18 is an in-r-difference indication diagram showing the existence of the in-r-difference between each of pixels and a first next-neighboring pixel in the second embodiment;

FIG. 19 is an in-r-difference indication diagram showing the existence of the in-r-difference between each of pixels and a second next-neighboring pixel in the second embodiment;

FIG. 20 is a deployment diagram regarding pixels showing the arrangement of pixels on the image sensor in the third embodiment;

FIG. 21 is an in-r-difference indication diagram showing the existence of the in-r-difference between each of pixels and a neighboring pixel in the third embodiment;

FIG. 22 is an in-r-difference indication diagram showing the existence of the in-r-difference between each of pixels and a first next-neighboring pixel in the third embodiment;

FIG. 23 is an in-r-difference indication diagram showing the existence of the in-r-difference between each of pixels and a second next-neighboring pixel in the third embodiment;

FIG. 24 is a deployment diagram regarding pixels showing the arrangement of pixels on the image sensor in the fourth embodiment;

FIG. 25 is an in-r-difference indication diagram showing the existence of the in-r-difference between each of pixels and a neighboring pixel in the fourth embodiment;

FIG. 26 is an in-r-difference indication diagram showing the existence of the in-r-difference between each of pixels and a first next-neighboring pixel in the fourth embodiment;

FIG. 27 is an in-r-difference indication diagram showing the existence of the in-r-difference between each of pixels and a second next-neighboring pixel in the fourth embodiment;

FIG. 28 is a deployment diagram regarding pixels showing the arrangement of pixels on the image sensor in the fifth to eighth embodiments;

FIG. 29 is a sectional view of the image sensor of the ninth embodiment;

FIG. 30 is a sectional view of the image sensor of the tenth embodiment;

FIG. 31 is a sectional view of the image sensor of the eleventh embodiment;

FIG. 32 is a sectional view of the image sensor of the twelfth embodiment;

FIG. 33 is a sectional view of the image sensor of the thirteenth embodiment;

FIG. 34 shows the contrast of the diffraction light of the first example;

FIG. 35 shows the contrast of the diffraction light of the second example;

FIG. 36 shows the contrast of the diffraction light of the third example;

FIG. 37 shows the contrast of the diffraction light of the fourth example; and

FIG. 38 shows the contrast of the diffraction light of the first comparative example.

### DESCRIPTION OF THE PREFERRED EMBODIMENTS

The present invention is described below with references to the embodiments shown in the drawings.

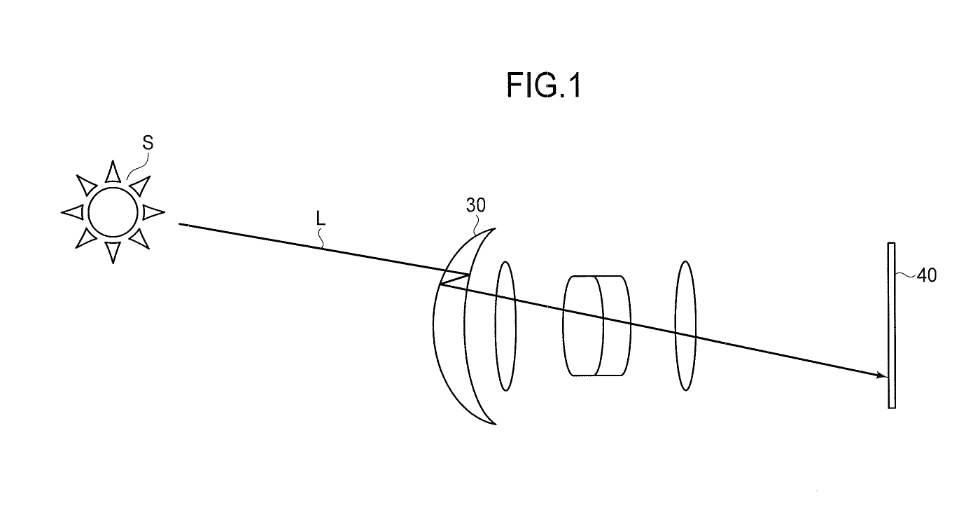

It is known that sunlight incident on an optical system of an imaging apparatus (not depicted) causes a ghost image to be captured in a photographed image. For example, as shown in FIG. 1, a ghost image is generated when incident light (see “L”) reflected inside a lens of an imaging optical system 30 is made incident on an image sensor 40. The ghost image has a single circular shape or a polygonal shape.

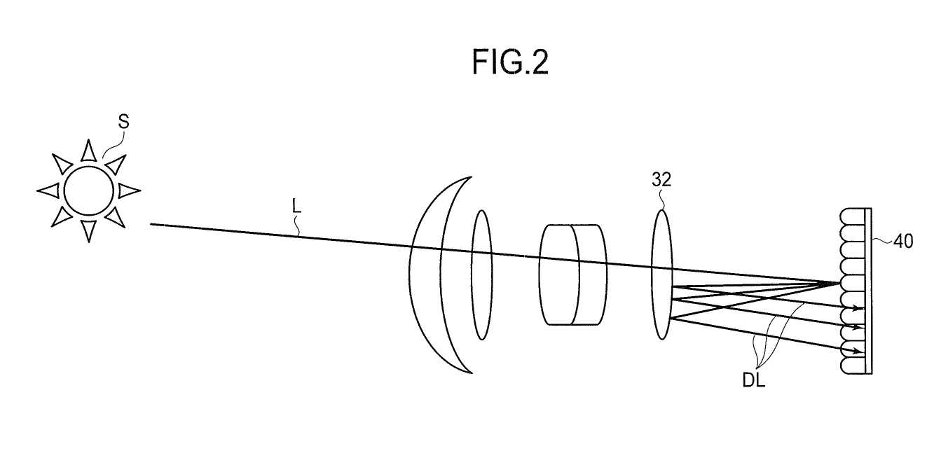

On the other hand, as shown in FIG. 2, when incident light is reflected by an image sensor 40 a plurality of beams of diffraction light (see “DL”) travels in various directions. The plurality of beams of light is reflected again by a lens 32 of the imaging optical system 30 and made incident on the image sensor 40. Accordingly, the ghost image generated by the plurality of beams has a polka-dot pattern consisting of a plurality of bright dots is arranged.

Such a polka-dot pattern causes the image quality of a photoelectric converted image to deteriorate. In the embodiment, the shape or pattern of a ghost image changes when improvements specifically designed to improve the image quality are made to the structure of an image sensor, as described below.

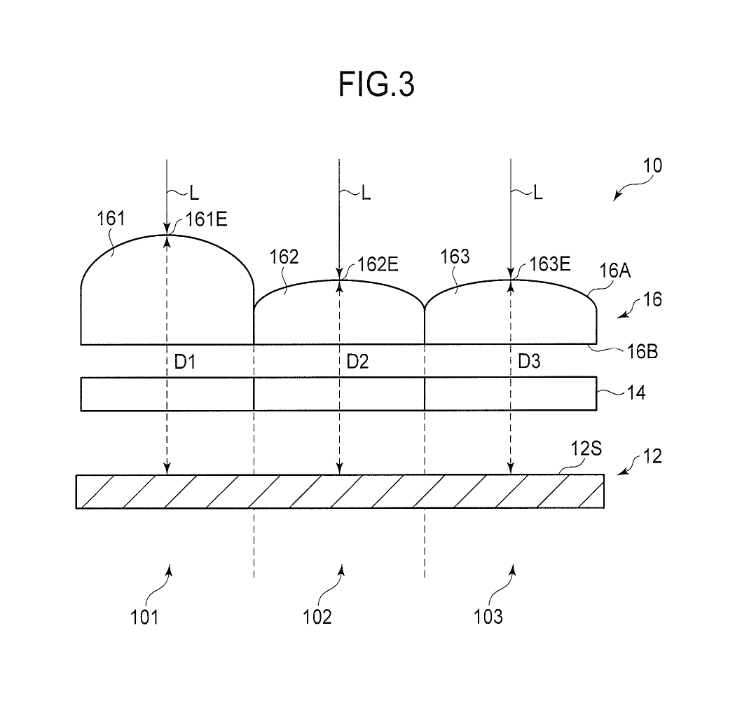

As shown in FIG. 3, an image sensor 10 of the first embodiment comprises a photoelectric conversion layer 12, a color filter 14, and micro-lens array 16. Light incident on the image sensor 10 strikes the micro-lens array 16, which is located at the outside surface of the image sensor 10.

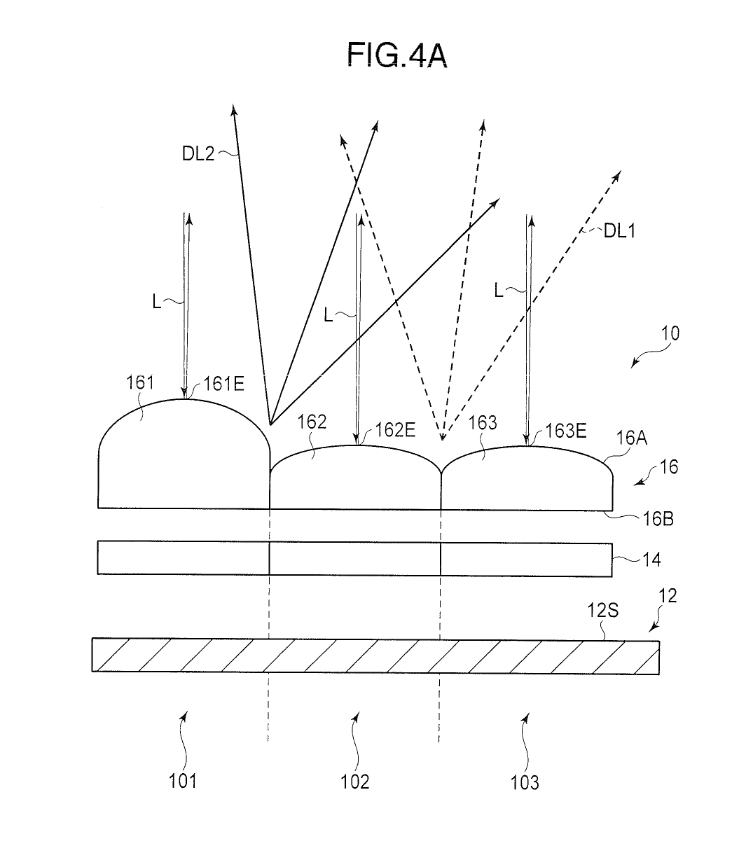

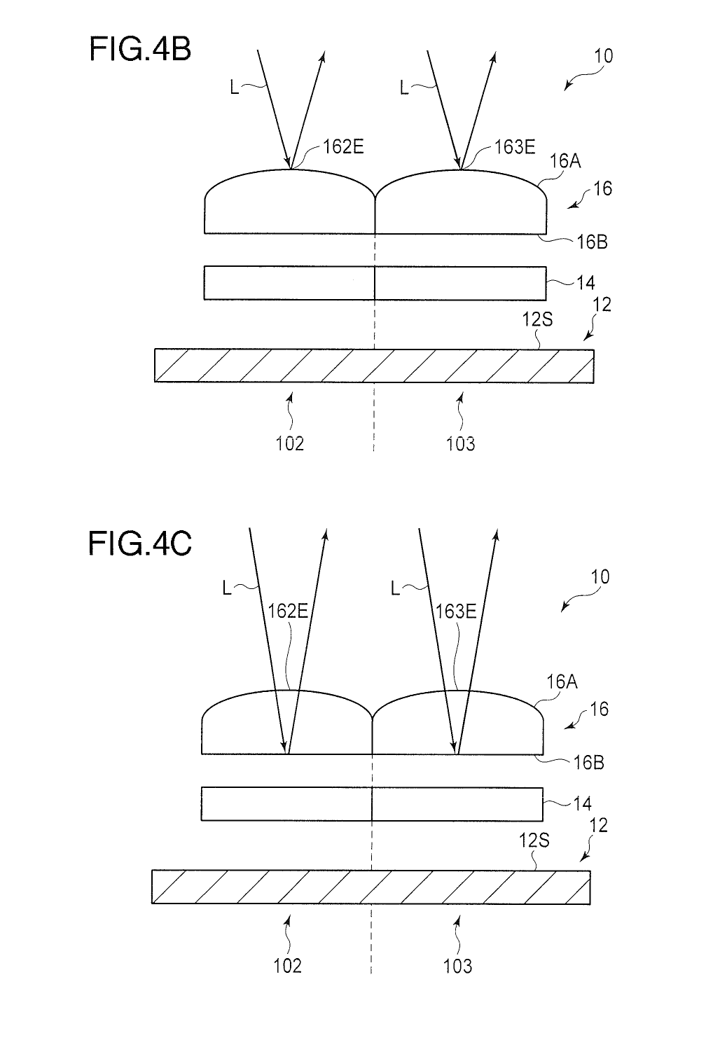

One part of the light (see “L”) incident on the micro-lens array 16 is reflected by an external surface 16A of the micro-lens array 16 (see FIGS. 3 and 4B). And the other part of the incident light passes through an external surface 16A and reaches an internal surface 16B of the micro-lens array 16. A part of the light that reaches the internal surface 16B is reflected by the internal surface 16B (see FIG. 4C).

In the first embodiment, the image sensor 10 comprises a plurality of pixels. Each of the pixels comprises one photoelectric converter of which a plurality is arranged on the photoelectric conversion layer 12, one color filter of which a plurality is arranged on the color filter layer 14, and one micro lens of which a plurality is arranged on the micro-lens array 16.

In the image sensor 10, the micro-lens array 16 is formed so that micro lenses having different thickness are arranged regularly. For example, a first micro lens 161 of a first pixel 101 is formed so that the thickness of the first micro lens 161 is greater than the thickness of second and third micro lenses 162, 163 of second and third pixels 102, 103. In addition, the second and third micro lenses 162, 163 are formed so that their thickness is equal to each other. Here, the thickness of the micro lens is the length between the top of the micro lens, for example a top point 161E of the external surface 16A, and the internal surface 16B.

Accordingly, distances (see “D2” and “D3” in FIG. 3) between the top points 162E, 163E of the second and third micro lens 162, 163 and the photoelectric conversion layer 12 are shorter than that (see “D1”) between the top point 161E of the first micro lens 161 and the photoelectric conversion layer 12.

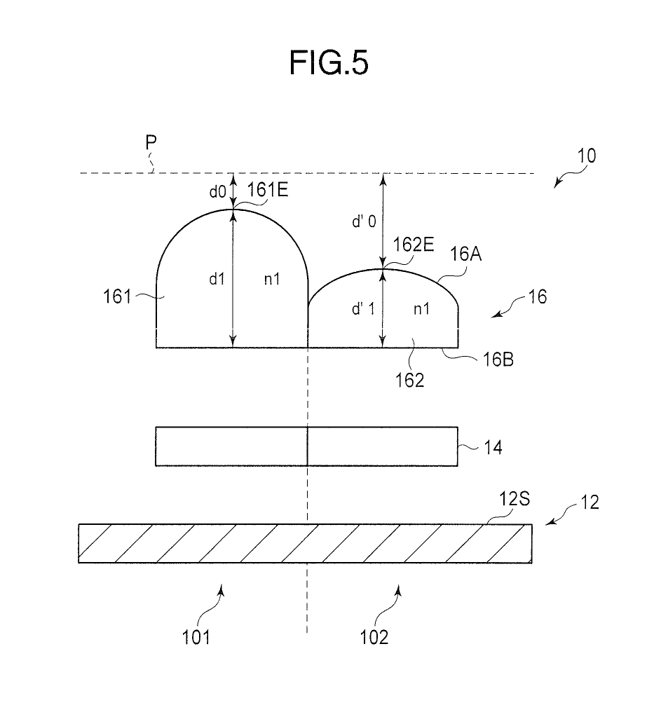

Next, external and internal optical path lengths (OPLs) are explained below. To explain the external and internal OPL, it is first necessary to designate a plane that is a parallel to a light-receiving area of the photoelectric conversion layer 12 and further from the photoelectric conversion layer 12 than the micro-lens array 16 as an imagined plane (see “P” in FIG. 5).

The external OPL is an integral value of the thickness of the substances and spaces between the imagined plane and the external surface 16A of the micro-lens array 16 multiplied by the respective refractive indexes of the substances and spaces. The internal OPL is an integral value of the thickness of the substances and spaces between the imagined plane and the internal surface 16B of the micro-lens array 16 multiplied by the respective refractive indexes of the subjects and spaces. In the first embodiment, the thickness of the respective substances and spaces used for the calculation of the external and internal OPLs is their length along a straight line that passes through the top point of the micro lens and is perpendicular to the light-receiving area of the photoelectric conversion layer 12.

For example, as shown in FIG. 5, the external OPL of the first and second pixels 101, 102 are (d0×n0) and (d′0×n0), respectively. An optical path length of light that travels from the imagined plane to the external surface 16A and is reflected by the external surface 16A back to the imagined plane is defined as an external reflected OPL. The external reflected OPL is twice as long as the external OPL.

Accordingly, the difference of the external reflected OPL, hereinafter referred to as e-r-difference, between the first and second pixels 101, 102 is calculated as ((d′0×n0)−(d0×n0))×2.

In the first embodiment, by varying per pixel the distance from the photoelectric conversion layer 12 to the external surface 16A of the micro lens 16, the e-r-difference of (distance from photoelectric conversion layer 12 to external surface 16A)×(refractive index of air)×2 is generated between two pixels.

In FIG. 5, the internal OPLs of the first and second pixels are (d0×n0)+(d1×n1) and (d′0×n0)+(d′1×n1), respectively. An optical path length of light that travels from the imagined plane to the internal surface 16B and is reflected by the internal surface 16B back to the imagined plane is defined as an internal reflected OPL. The internal reflected OPL is twice as long as the internal OPL.

Accordingly, the difference of the internal reflected OPL, hereinafter referred to as i-r-difference, between the first and second pixels 101, 102 is calculated as ((d′0×n0)+(d′1×n1)−(d0×n0)−(d1×n1))×2. Using the equation of (d′0+d′1)=(d0+d1), the i-r-difference is calculated as ((d1−d′1)×(n1−n0))×2. Accordingly, the i-r-difference is calculated as (difference between thickness of micro lenses)×(difference between refractive indexes of micro-lens array 16 and air)×2. In the above and below calculation, the refractive index is determined to be 1.

In the image sensor 10 having the e-r-difference or the i-r-difference, the direction of the diffraction light generated by the reflection of incident light at the external or internal surface 16A, 16B of a pair of pixels varies according to the dimensions of the pair of pixels.

For example, shown in FIG. 4A, the e-r-difference between the second and third pixels 102, 103 is mλ (m being an integer and zero in this case, and λ being the wavelength of light incident on the micro lens). Accordingly, the phases of the light reflected by the second and third pixels are the same. First diffraction light (see “DL1”) generated between the second and third pixels, of which the phases are same, travel in the directions indicated by the dashed lines.

On the other hand, the micro-lens array 16 is configured so that the difference in thickness between the micro lenses of the first and second pixels 101, 102 is (m+1/2)×λ. Accordingly, a phase difference is generated between the first and second pixels. Second diffraction light (see “DL2”) generated between the first and second pixels, of which the phases are different, travels in the directions indicated by the solid lines.

The direction of the second diffraction light is in the center direction between the directions of neighboring first diffraction light. Hereinafter, the diffraction light, which travels in the center direction between two directions of integer degree diffraction light, is called half-degree diffraction light. Similar to half-degree diffraction light, diffraction light that travels in the center direction between the directions of half- and integer-degree diffraction light is called quarter-degree diffraction light.

The directions of diffraction light can be increased by changing the direction of the diffraction light resulting from the external reflected OPL between two pixels. For example, by producing half-degree diffraction light the diffraction light that travels between zero- and one-degree diffraction light is generated.

In addition and similar to the e-r-difference, the directions of diffraction light based on the reflection at the internal surface can be increased by generating the i-r-difference between two pixels and changing the direction of the diffraction light.

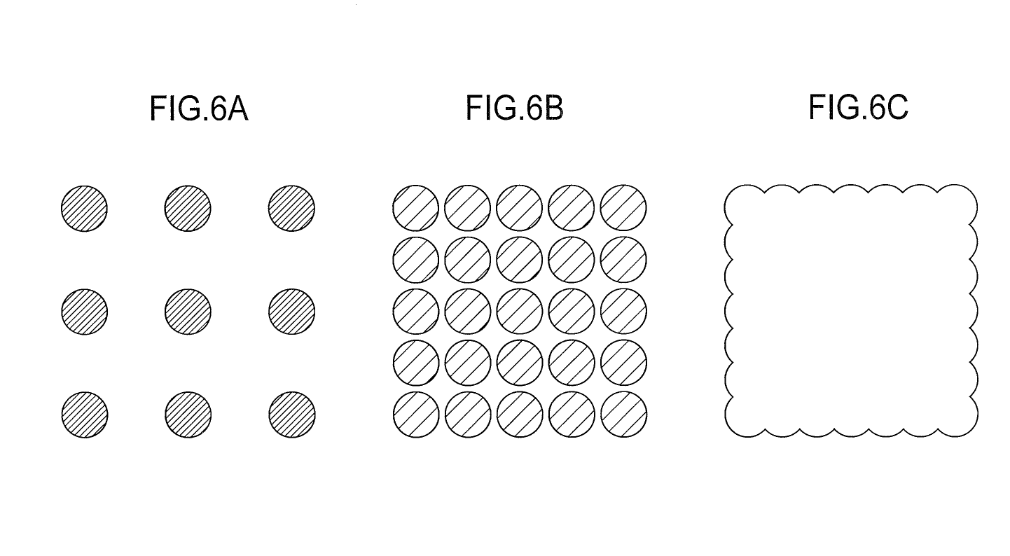

The contrast of a ghost image based on the diffraction light generated by reflection, hereinafter referred to as an r-d-ghost image, can be reduced by increasing the directions of the diffraction light. The mechanism to reduce the contrast of the r-d-ghost image is explained below using FIG. 6. FIG. 6 is a polka-dot pattern of the ghost image generated by various image sensors.

Using the image sensor 40 (see FIG. 2), which has no e-r-difference between pixels, the generated diffraction light based on the reflection at the external surface of the micro-lens array 16 travels in the same directions between any pairs of pixels. Accordingly, as shown in FIG. 6A, the contrast of the ghost image based on the diffraction light using the image sensor 40 is relatively high. Consequently, the brightness of the dots in the polka-dot pattern of the ghost image is emphasized.

Using the image sensor of the first embodiment, the direction of partial diffraction light is changed and the diffraction light travels in various directions. Accordingly, as shown in FIGS. 6B and 6C, the contrast of the ghost image based on the diffraction light using the image sensor of the first embodiment is reduced.

Accordingly, even if the r-d-ghost image appears, each of the dots is unnoticeable because the number of dots within a certain size of the polka-dot pattern increases and the brightness of each dot decreases. Consequently, the image quality is prevented from deteriorating due to the r-d-ghost image. As described above, in the first embodiment the impact of the r-d-ghost image on an image to be captured is reduced, and a substantial appearance of the r-d-ghost image is prevented.

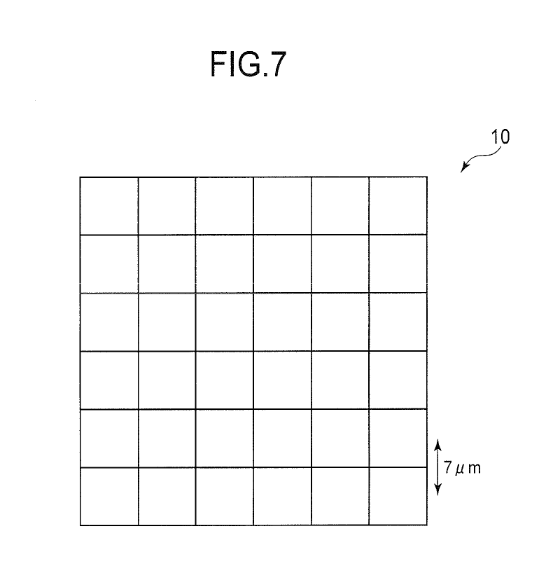

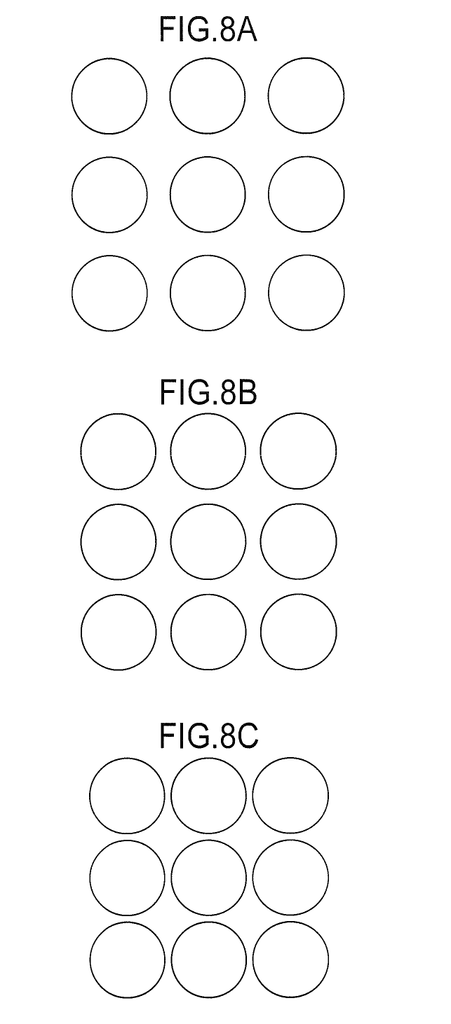

Next, the arrangement of color filters is explained below using FIG. 7. In addition, the breadth of the diffraction light for each of the colors is explained below using FIG. 8. FIG. 7 is a plane view of a part of the image sensor 10. FIG. 8 is a polka-dot pattern of the r-d-ghost image for different colors of light.

In the image sensor 10, the pixels are two-dimensionally arranged in rows and columns. Each pixel comprises one of a red, green or blue color filter. The color filter layer 14 comprises red, green, and blue color filters. The red, green, and blue color filters are arranged according to the Bayer color array. Hereinafter, pixels having the red, green, and blue color filters are referred to as r-pixels, g-pixels and b-pixels, respectively.

The distance between two pixels that are nearest to each other, hereinafter referred to as a pixel distance, is 7 μm for example. The diffraction angle of the diffraction light (see “DL” in FIG. 4A) is calculated as (wavelength of reflected light)/(pixel distance). The angle between the directions in which diffraction light of two successive integer degrees travels, such as a combination of zero and one-degree diffraction light and a combination of one- and two-degree diffraction light, is defined as the diffraction angle.

The wavelength of the light reflected at the external and internal surface of the micro-lens array 16 varies broadly. However, for the purpose of reducing the influence of the r-d-ghost image it is sufficient to consider a diffraction angle that is calculated on the basis of one representative wavelength in the band of light reflected at the external and internal surface for each pixel.

The light that is reflected at the external or internal surface 16A, 16B of the micro-lens array 16 and reflected by the lens 32 (see FIG. 2) before traveling toward the image sensor 10 is white light because it does not pass through the color filter layer 14. However, the light eventually does pass through the color filter layer 14 and is made incident on the photoelectric conversion layer 12. Accordingly, it is sufficient to consider a diffraction angle using a certain wavelength in a wavelength band of light that passes through the color filter for each pixel for the purpose of reducing the influence of the r-d-ghost image.

For example, a representative wavelength in a wavelength band of red light that passes through the red color filter is determined to be 640 nm. A representative wavelength in a wavelength band of green light that passes through the green color filter is determined to be 530 nm. A representative wavelength in a wavelength band of blue light that passes through the blue color filter is determined to be 420 nm.

The pixel distance in the first embodiment is about 7 μm, for example, as described above and shown in FIG. 7. Accordingly, the diffraction angle of the diffraction light generated based on the reflection at the external surface 16A of the r-pixel is 640 nm/7 μm=91 rad (see FIG. 8A). The diffraction angle of the diffraction light generated based on the reflection at the external surface 16A of the g-pixel is 530 nm/7 μm=76 rad (see FIG. 8B). The diffraction angle of the diffraction light generated based on the reflection at the external surface 16A of the b-pixel is 420 nm/7 μm=60 rad, which is the smallest among the diffraction angles for r-, g-, and b-pixels (see FIG. 8C).

As described above, the diffraction angle varies according to wavelength. In order to maximize the effect of lowering the contrast, m+0.5 degree diffraction light (m being a certain integer) is generated between two pixels. To generate the m+0.5 degree diffraction light, it is preferable to change the e-r-difference or the i-r-difference according to a wavelength within the wavelength band of the light that reaches the photoelectric conversion layer 12. In the first embodiment, it is preferable to change the e-r-difference or the i-r-difference according to wavelength of red, green or blue light.

However, even if the generated diffraction light is not m+0.5 degree diffraction light, the ghost image can still be adequately dispersed. Accordingly, calculation of the e-r-difference or the i-r-difference using the wavelength of 530 nm, which is the middle value among 640 nm, 530 nm, and 420 nm for the r-pixel, g-pixel and b-pixel, is sufficient to determine the shape of the micro-lens array that will reduce the effect of the ghost image. Even if the e-r-difference or i-r-difference is determined using the wavelength of 530 nm, the ghost image can be dispersed for the r-pixel and b-pixel.

In the first embodiment, the micro-lens array 16 is formed so that part of the pairs of pixels has the e-r-difference or the i-r-difference of (m+1/2)×λ (m being a certain integer and λ being 530 nm for the middle wavelength within the wavelength band of green light).

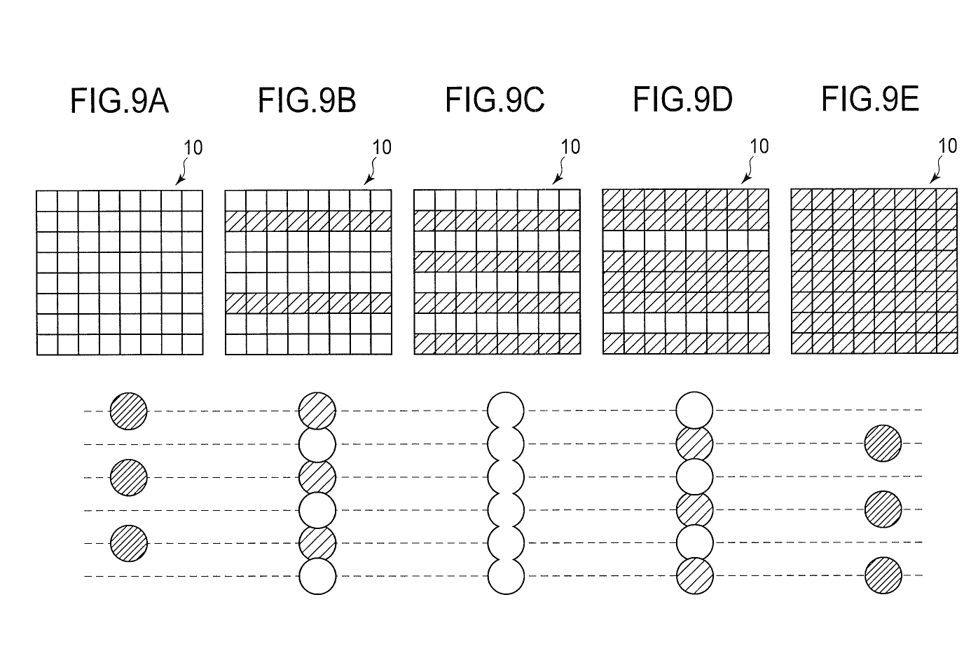

Next, the relationship between the effect of reducing the contrast and the arrangement of pixels having an e-r-difference with respect to a typical pixel is explained. Only the arrangement of pixels having an e-r-difference is explained below, but the arrangement of pixels having an i-r-difference is similar to that of the e-r-difference. FIG. 9 conceptually shows the relation between the arrangement of pixels that have the e-r-difference with another pixel and the contrast of diffraction light.

As shown in FIG. 9A, when the external reflected OPL is equal for all pixels of the image sensor 10, the contrast of the diffraction light is great. In such a case, the phases of the light reflected at the external surfaces 16A of any pair of neighboring pixels are equal. Accordingly, the first diffraction light (see “DL1” in FIG. 5) which travels in the same direction (see dashed line) is generated between all pairs of neighboring pixels. The polka-dot pattern having high contrast is generated because the diffraction light forms bright dots by concentrating the diffraction light on the same area of the image sensor.

As shown in FIG. 9B, the contrast is reduced slightly by arranging pixels so that some pairs of neighboring pixels have the e-r-difference. Some pairs of neighboring pixels have the e-r-difference by making the external reflected OPL longer for some pixels and shorter for other part of pixels. In FIGS. 9B to 9(E), the pixels having the longer external reflected OPL, hereinafter referred to as lengthened pixels, are shaded whereas the pixels having the shorter external reflected OPL, hereinafter referred to as normal pixels, are white.

As shown in FIG. 9C, the contrast of the diffraction light is reduced substantially by arranging pixels so that half of all pixels are lengthened pixels are. In such a case, the first diffraction light (see “DL1” in FIG. 4A) that travels in the same direction (see dashed line) is generated between half of the pairs of neighboring pixels, and the second diffraction light (see “DL2”) that travels in a direction (see continuous line) different from that of the first diffraction light is generated between the other half of pairs of neighboring pixels. In this case, roughly half of the diffraction light reaches an area that the other half does not reach. Accordingly, the contrast of the diffraction light is minimized.

When more than half of pixels are the lengthened pixels (see FIG. 9D), the contrast is greater than the contrast derived from an image sensor having an equal number of lengthened pixels and normal pixels. When all of the pixels are lengthened pixels (see FIG. 9(E)), the contrast is even greater.

When all of pixels are lengthened pixels, the external reflected OPL is equal for all pixels. For example using FIG. 4A, the second diffraction light (see “DL2” in FIG. 5) that travels in the same direction (see continuous line) is generated between all neighboring pixel pairs. In other words, the first diffraction light is not generated. Accordingly, though the direction of the diffraction light changes from the case shown in FIG. 9A, the contrast of the diffraction light is mostly same as that in the case shown in FIG. 9A.

Accordingly, it is necessary to vary the direction of the diffraction light by arranging pixels so that some of the pairs of pixels have the e-r-difference. In addition, it is particularly desirable for half of all of pixel pairs to have an e-r-difference.

For example, a diffraction angle of one-half is obtained by equally mixing the integer-degree diffraction light with the half-degree diffraction light. Next, the arrangement of the lengthened pixels and the e-r-difference are explained below.

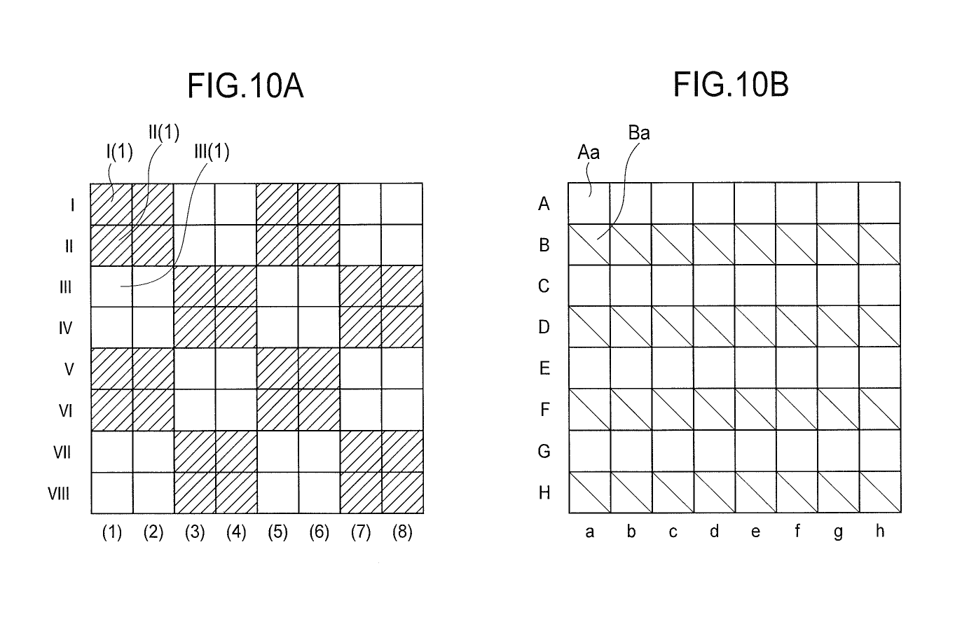

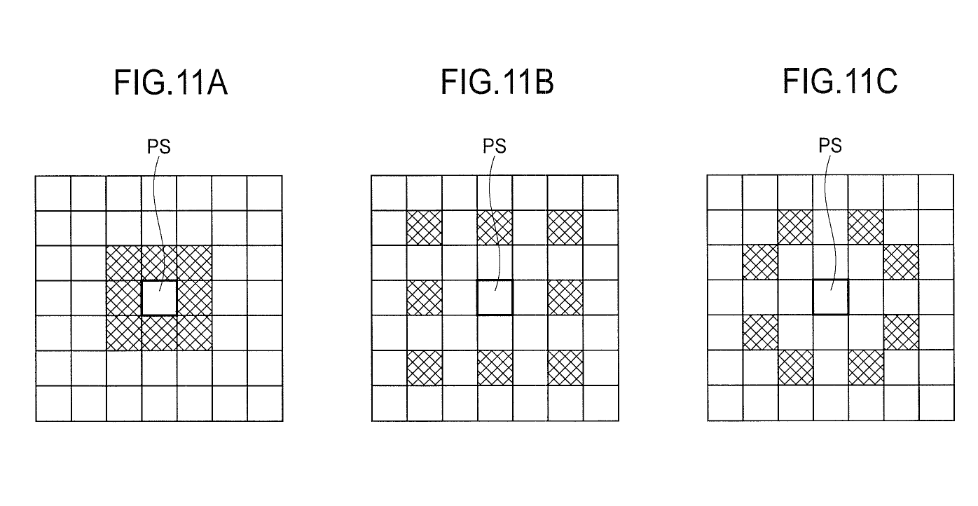

The arrangement of pixels of the first embodiment and the effect are explained using a pixel deployment diagram and an e-r-difference diagram. The example of the pixel deployment diagram and the e-r-difference diagram is illustrated in FIG. 10. In addition, the definitions of a neighboring pixel and a next-neighboring pixel for a target pixel are explained below using FIG. 11.

FIG. 10 shows the relation between the arrangement of the lengthened pixels and the normal pixels, and the e-r-difference between pixel pairs. FIG. 11 shows the relative positions of neighboring pixels, and first and second next-neighboring pixels with respect to a target pixel.

The normal pixels (white panels in FIG. 10A) that have the shorter external OPLs and the lengthened pixels (shaded panels in FIG. 10A) that have longer external OPLs are located on the image sensor 10. The e-r-difference between the lengthened pixel and normal pixel is (m+1/2)×λ.

The external reflected OPL is twice as great as the external OPL, as described above. Accordingly, when the external OPL is equal for some pixel pairs, the external reflected OPL is also equal for those same pixel pairs. Ideally the e-r-difference between normal and lengthened pixels is (m+1/2)×λ. However, the phase difference can be shifted to higher or lower. In other words, the e-r-difference may be shifted slightly from (m+1/2)×λ.

FIG. 10B shows the e-r-difference between target pixels, which are designated one-by-one among all of the pixels in FIG. 10A, and their respective neighboring pixels arranged one row below the target pixel. In FIG. 10B, the white panels indicate pixels that do not have an e-r-difference with respect to their neighboring pixel positioned one row below while the panels marked with diagonal lines represent pixels that have an e-r-difference with respect to their neighboring pixels arranged one row below.

For example, in FIG. 10A, the external OPL of the pixel represented by the panel at the intersection of the top row and first (leftmost) column is equal to that of the pixel positioned in the second row of the first column. Accordingly, in FIG. 10B, the panel representing the pixel arranged in the first row and the first column is white.

In the first and the other embodiments, a neighboring pixel of a target pixel is not limited to a pixel that is adjacent to the target pixel, but instead indicates a pixel nearest to the target pixel among the same color pixels, i.e. r-, g-, or b-pixels.

In addition, in FIG. 10A, an e-r-difference exists between the pixel arranged in the second row of the first column and the pixel arranged in the third row of the first column. Accordingly, in FIG. 10B, the pixel arranged in the second row of the first column is represented by a panel with a diagonal line.

The arrangement of the pixel and the effect derived from the arrangement in the first embodiment are explained below using the pixel deployment diagram, such as FIG. 10A, which shows the arrangement of the lengthened and normal pixels, and an e-r-difference diagram, such as FIG. 10B, which shows the e-r-difference for each pixel with respect to another pixel.

In FIG. 10B, the e-r-difference between a target pixel and a neighboring pixel arranged one row below is shown in order to indicate the diffraction light generated between pairs of neighboring pixels. However, diffraction light is not limited to light generated only from pairs of a target pixel and a neighboring pixel arranged one row below.

As shown in FIG. 11A, eight shaded panels represent eight neighboring pixels surrounding one target pixel represented by the white panel marked with “PS”. The diffraction light based on the reflection is generated between the target pixel and each of the eight neighboring pixels. As shown in FIGS. 11B and 11C, sixteen pixels surrounding the eight neighboring pixels are defined as the next-neighboring pixels (see shaded panels). The diffraction light based on the reflection is also generated between the target pixel and each of the sixteen next-neighboring pixels.

The next-neighboring pixels are categorized into first and second next-neighboring pixels. The first next-neighboring pixels are the eight pixels arranged every 45 degree and include the pixels on the same vertical and horizontal lines as the target pixel (see shaded panels in FIG. 11B). The second next-neighboring pixels are the eight other next-neighboring pixels positioned in between the first next-neighboring pixels (see shaded panels in FIG. 11C).

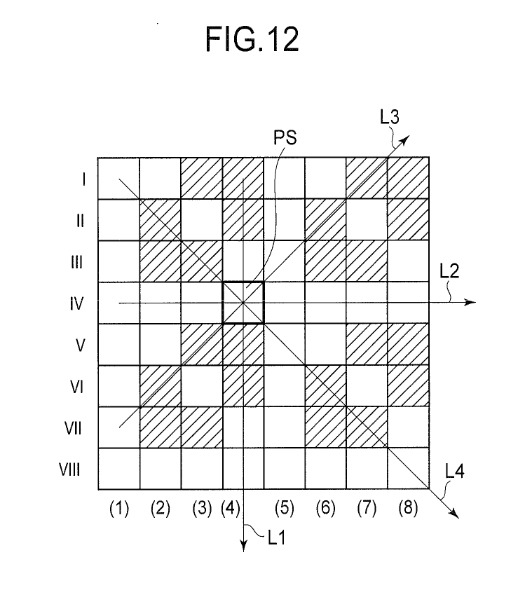

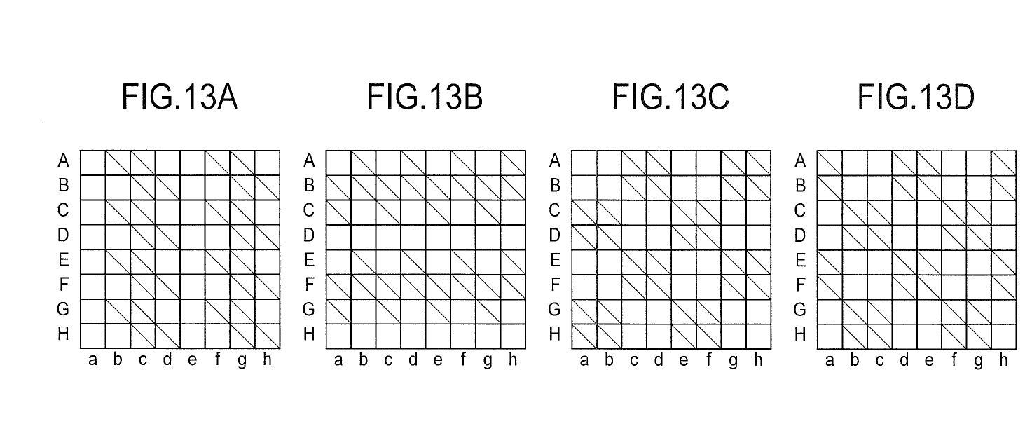

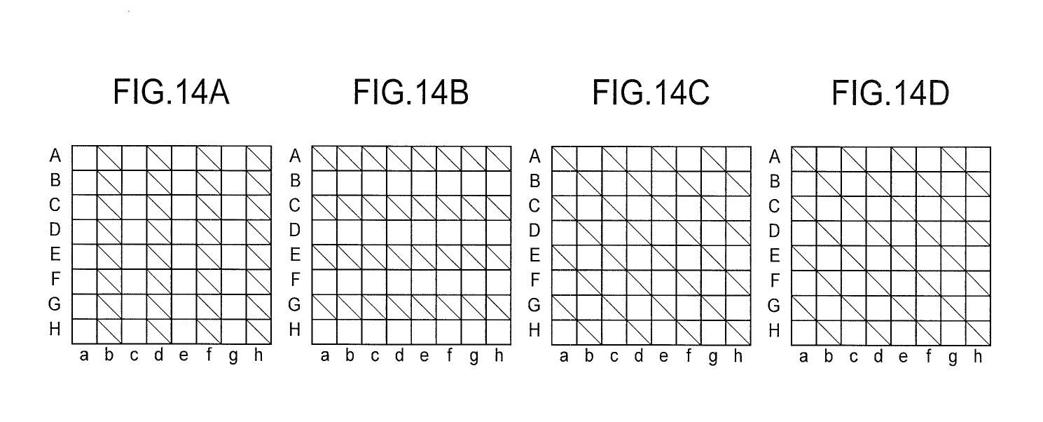

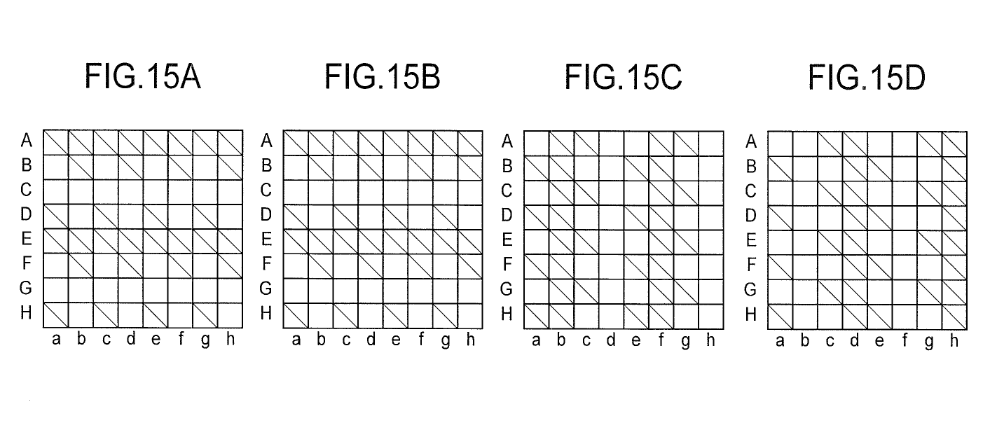

FIG. 12 is a pixel deployment diagram showing the arrangement of pixels on the image sensor 10 of the first embodiment. FIG. 13 is an e-r-difference diagram mapping the e-r-difference between each of pixels and a neighboring pixel in the first embodiment. FIG. 14 is an e-r-difference diagram mapping the e-r-difference between each of pixels and a first next-neighboring pixel in the first embodiment. FIG. 15 is an e-r-difference diagram mapping the e-r-difference between each of pixels and a second next-neighboring pixel in the first embodiment.

In FIG. 12 and in the other pixel deployment diagrams, first to fourth lines (see “L1 to L4”) are imaginary lines passing the target pixel (see “PS”). The first line is a vertical line. The second line is a horizontal line. The third line is a diagonal line toward the upper-right direction from the target pixel. The fourth line is a diagonal line toward the lower-right direction from the target pixel. The first and second lines are perpendicular. The third and fourth lines are perpendicular. The arrangement shown in FIG. 12 is repeated over the entire light-receiving area of the image sensor 10.

FIG. 13A maps the e-r-difference between pairs comprising a target pixel and neighboring pixel positioned one row below.

FIG. 13A shows the existence of the e-r-difference between a target pixel, which is designated one-by-one among all pixels, and a neighboring pixel arranged one row below the target pixel. In FIG. 13A, the panels with a diagonal line indicate that a pixel paired with a pixel arranged one row below have the e-r-difference, similar to FIG. 10B. On the other hand, in FIG. 13A, the white panels indicate that a pixel paired with a pixel arranged one row below have the same external reflected OPLs.

Hereinafter, a pair of pixels that includes a target pixel and a neighboring or next-neighboring pixel relative to the target pixel is referred to as a pixel pair.

As shown in FIG. 13A, among pixel pairs including a target pixel and a neighboring pixel positioned one row below the target pixel, the number of pixel pairs having the e-r-difference is equal to the number of pixel pairs having the same external reflected OPL. Although only pixel pairs including target pixels and neighboring pixels arranged one row below are considered in FIG. 13A, a similar result is obtained for pixel pairs including target pixels and neighboring pixels arranged one row above the target pixel.

FIG. 13B maps the e-r-difference between pixel pairs comprising a target pixel and a neighboring pixel arranged one column to the right of the target pixel. As shown in FIG. 13B, among pixel pairs consisting a target pixel and a neighboring pixel positioned one column to the right, the number of pixel pairs having the e-r-difference is equal to the number of pixel pairs having the same external reflected OPL.

FIG. 13C maps the e-r-difference between pixel pairs comprising a target pixel and a neighboring pixel arranged one row above and one column to the right of the target pixel. As shown in FIG. 13C, among pixel pairs including a target pixel and a neighboring pixel positioned one row above and one column to the right, the number of pixel pairs having the e-r-difference is equal to the number of pixel pairs having the same external reflected OPL.

FIG. 13D maps the e-r-difference between pixel pairs comprising a target pixel and a neighboring pixel arranged one row below and one column to the right of the target pixel. As shown in FIG. 13D, among pixel pairs including a target pixels and a neighboring pixel positioned one row below and one column to the right, the number of pixel pairs having the e-r-difference is equal to the number of pixel pairs having the same external reflected OPL.

FIG. 14A maps the e-r-difference between pixel pairs comprising a target pixel and a first next-neighboring pixel arranged two rows below the target pixel. As shown in FIG. 14A, among pixel pairs including a target pixel and a first next-neighboring pixel arranged two rows below, the number of pixel pairs having the e-r-difference is equal to the number of pixel pairs having the same external reflected OPL.

FIG. 14B maps the e-r-difference between pixel pairs comprising a target pixel and a first next-neighboring pixel arranged two columns to the right of the target pixel. As shown in FIG. 14B, among pixel pairs including a target pixel and a first next-neighboring pixel positioned two columns to the right, the number of pixel pairs having the e-r-difference is equal to the number of pixel pairs having the same external reflected OPL.

FIG. 14C maps the e-r-difference between pixel pairs comprising a target pixel and a first next-neighboring pixel arranged two rows above and two columns to the right of the target pixel. As shown in FIG. 14C, among pixel pairs including a target pixel and a first next-neighboring pixel positioned two rows above and two columns to the right, the number of pixel pairs having the e-r-difference is equal to the number of pixel pairs having the same external reflected OPL.

FIG. 14D maps the e-r-difference between pixel pairs comprising a target pixel and a first next-neighboring pixel arranged two rows below and two columns to the right of the target pixel. As shown in FIG. 14D, among pixel pairs including a target pixel and a first next-neighboring pixel positioned two rows below and two columns to the right, the number of pixel pairs having the e-r-difference is equal to the number of pixel pairs having the same external reflected OPL.

FIG. 15A maps the e-r-difference between pixel pairs comprising a target pixel and a second next-neighboring pixel arranged two rows below and one column to the right of the target pixel. As shown in FIG. 15A, among pixel pairs including a target pixel and a second next-neighboring pixel positioned two rows below and one column to the right, the number of pixel pairs having the e-r-difference is equal to the number of pixel pairs having the same external reflected OPL.

FIG. 15B maps the e-r-difference between pixel pairs comprising a target pixel and a second next-neighboring pixel arranged two rows above and one column to the right of the target pixel. As shown in FIG. 15B, among pixel pairs including a target pixel and a second next-neighboring pixel positioned two rows above and one column to the right, the number of pixel pairs having the e-r-difference is equal to the number of pixel pairs having the same external reflected OPL.

FIG. 15C maps the e-r-difference between pixel pairs comprising a target pixel and a second next-neighboring pixel arranged one row below and two columns to the right of the target pixel. As shown in FIG. 15C, among pixel pairs including a target pixel and a second next-neighboring pixel positioned one row below and two columns to the right, the number of pixel pairs having the e-r-difference is equal to the number of pixel pairs having the same external reflected OPL.

FIG. 15D maps the e-r-difference between pixel pairs comprising a target pixel and a second next-neighboring pixel arranged one row above and two columns to the right of the target pixel. As shown in FIG. 15D, among pixel pairs including a target pixel and a second next-neighboring pixel positioned one row above and two columns to the right, the number of pixel pairs having the e-r-difference is equal to the number of pixel pairs having the same external reflected OPL.

In the above first embodiment, the number of pixel pairs including a target pixel and either a neighboring pixel, first next-neighboring pixel or second next-neighboring pixel for all directions and that have the e-r-differences of (m+1/2)×λ is equal to the number of pixel pairs having the same external reflected OPL.

Also, in the first embodiment, a pixel unit comprises 16 pixels, which are either lengthened or normal pixels, and are arranged in four rows by four columns in a specific arrangement pattern (see FIG. 12). A plurality of pixel units is repeatedly and successively arranged vertically and horizontally on the image sensor 10.

The size of the pixel unit is determined on the basis of the diffraction limit for wavelength of incident light. In other words, the size of the pixel unit is determined so that the size substantially accords with the diameter of an airy disk. For example, for a commonly used imaging optical system, the length of one side of the pixel unit is determined to be roughly less than or equal to 20 μm-30 μm.

The contrast of the diffraction light can be effectively reduced by rearranging the lengthened and normal pixels in each pixel unit, which are nearly equal in size to a light spot formed by the concentration of incident light from a general optical system, so that the number of pixel pairs with and without the e-r-differences are in accordance with the scheme described above.

In the above first embodiment, the contrast of the diffraction light based on the reflection at the external surface of the micro-lens array 16 can be reduced by rearranging the pixel pairs with the e-r-differences of (m+1/2)×λ to create phase-differences between the reflected light from pairs of pixels. By reducing the contrast of the diffraction light, the influence of the r-d-ghost image can be mitigated.

In addition, in the above first embodiment, the micro-lens array 16 having various thicknesses can be manufactured more easily than a micro lens with finely dimpled surfaces. Accordingly, the image sensor 10 can be manufactured more easily and the manufacturing cost can be reduced.

Next, an image sensor of the second embodiment is explained. The primary difference between the second embodiment and the first embodiment is the arrangement of normal pixels and lengthened pixels. The second embodiment is explained mainly with reference to the structures that differ from those of the first embodiment. To simplify matters, the same index numbers from the first embodiment will be used for corresponding structures in the second embodiment.

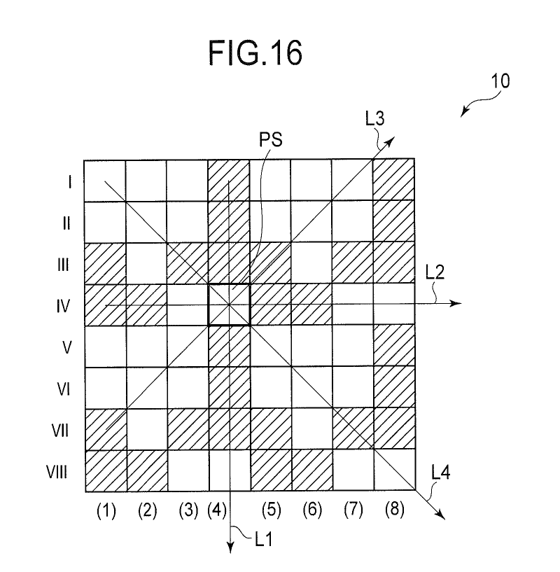

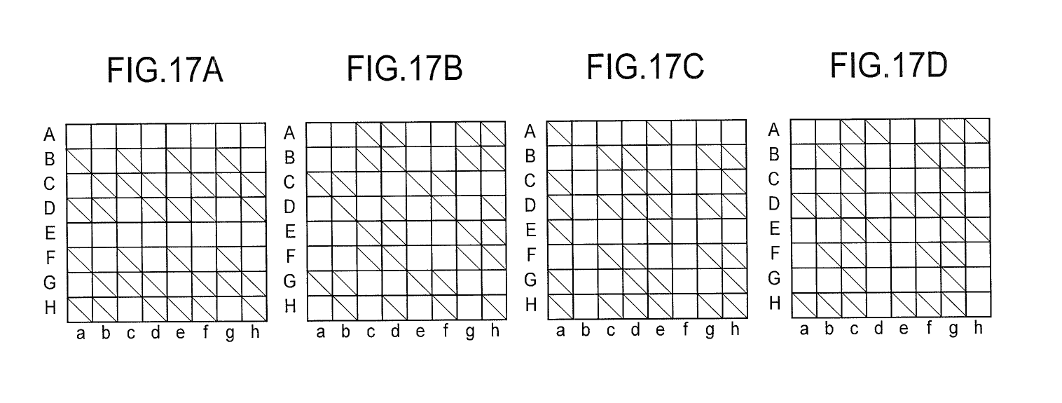

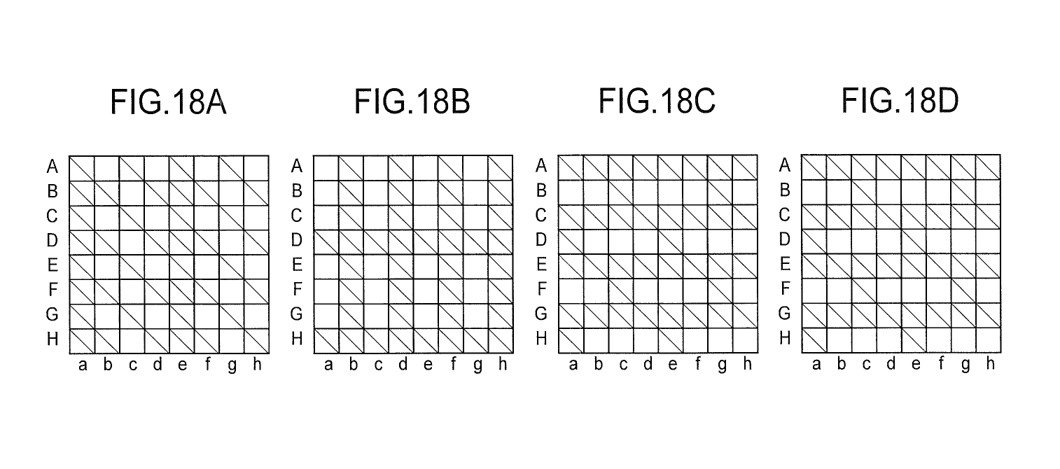

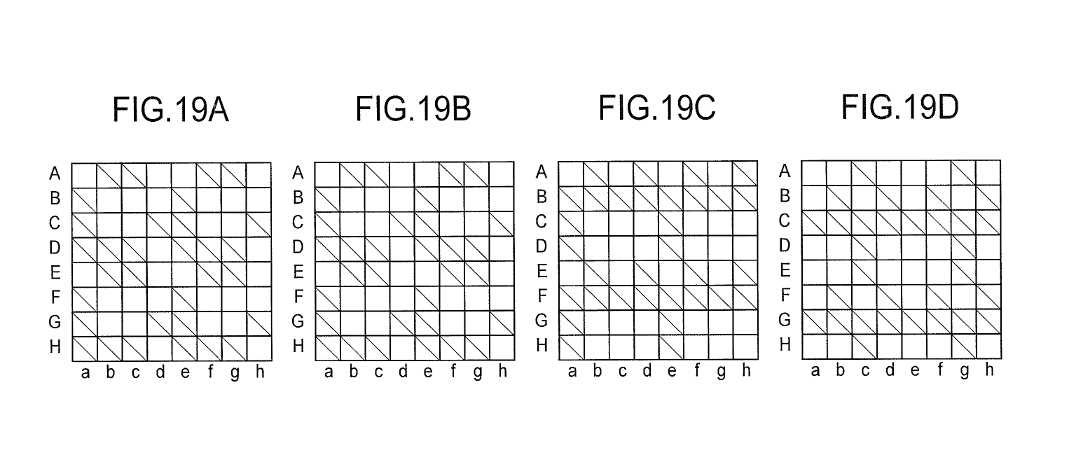

FIG. 16 is a pixel deployment diagram showing the arrangement of pixels on the image sensor 10 in the second embodiment. FIG. 17 is an e-r-difference diagram mapping the e-r-difference between each of the pixels and a neighboring pixel in the second embodiment. FIG. 18 is an e-r-difference diagram mapping the e-r-difference between each of the pixels and a first next-neighboring pixel in the second embodiment. FIG. 19 is an e-r-difference diagram mapping the e-r-difference between each of the pixels and a second next-neighboring pixel in the second embodiment.

FIG. 17A maps the e-r-difference between pixel pairs including a target pixel and a neighboring pixel arranged one row below the target pixel; FIG. 17B maps the e-r-differences between pixel pairs including a target pixel and a neighboring pixel arranged one column to the right of the target pixel; FIG. 17C maps the e-r-differences between pixel pairs including a target pixel and a neighboring pixel arranged one row above and one column to the right of the target pixel; and FIG. 17D maps the e-r-differences between pixel pairs including a target pixel and a neighboring pixel arranged one row below and one column to the right of the target pixel.

As shown in FIGS. 17A to 17D, among the pixel pairs comprising a target pixel and a neighboring pixel arranged in any direction from the target pixels, the number of pixel pairs having the e-r-difference is equal to the number of pixel pairs having the same external reflected OPL.

FIG. 18A maps the e-r-difference between pixel pairs including a target pixel and a first next-neighboring pixel arranged two rows below the target pixel; FIG. 18B maps the e-r-differences between pixel pairs including a target pixel and a neighboring pixel arranged two columns to the right of the target pixel; FIG. 18C maps the e-r-differences between pixel pairs including a target pixel and a neighboring pixel arranged two rows above and two columns to the right of the target pixel; and FIG. 18D maps the e-r-differences between pixel pairs of a target pixel and a neighboring pixel arranged two rows below and two columns to the right of the target pixel.

As shown in FIGS. 18A to 18D, among the pixel pairs comprising a target pixel and a first next-neighboring pixel arranged in any direction from the target pixel, the number of pixel pairs having the e-r-difference is greater than the number of pixel pairs having the same external reflected OPL. The ratio of pixel pairs having the e-r-differences to all pixel pairs is about 63%.

FIG. 19A maps the e-r-difference between pixel pairs including a target pixel and a second next-neighboring pixel in the same arrangement as FIG. 15A; FIG. 19B maps the e-r-difference between pixel pairs including a target pixel and a neighboring pixel in the same arrangement as FIG. 15B; FIG. 19C maps the e-r-difference between pixel pairs including a target pixel and a neighboring pixel in the same arrangement as FIG. 15C; and FIG. 19D maps the e-r-difference between pixel pairs including a target pixel and a neighboring pixel in the same arrangement as FIG. 15D.

As shown in FIGS. 19A to 19D, among the pixel pairs comprising a target pixel and a second next-neighboring pixel arranged in any directions from the target pixels, the number of pixel pairs having the e-r-difference is equal to the number of pixel pairs having the same external reflected OPL.

In the above second embodiment, the number of pixel pairs having the e-r-differences of (m+1/2)×λ and comprising a target pixel and either a neighboring pixel or second next-neighboring pixel in any direction from the target pixel is equal to the number of pixel pairs having the same external reflected OPL. However, the number of pixel pairs having the e-r-difference and comprising a target pixel and a first next-neighboring pixel in any direction from the target pixels is greater than the number of pixel pairs having the same external reflected OPL.

In the above second embodiment, the contrast of the diffraction light based on the reflection at the external surface of the micro-lens array 16 can be reduced by rearranging the pixel pairs with the e-r-difference of (m+1/2)×λ between the pair. By reducing the contrast of the diffraction light, the influence of the r-d-ghost image can be mitigated.

The second embodiment is different from the first embodiment, in that the number of pixel pairs having the e-r-difference among all of the pixel pairs comprising a target pixel and a first next-neighboring pixel is greater than the number of the pixel pairs having the same external reflected OPL. Accordingly, the effect from reducing the influence of the r-d-ghost image in the second embodiment is less than that in the first embodiment. However, the influence of the r-d-ghost image can be sufficiently reduced in comparison to an image sensor having pixels with equal external reflected OPLs.

Next, an image sensor of the third embodiment is The primary difference between the third embodiment and the first embodiment is the arrangement of normal pixels and lengthened pixels. The third embodiment is explained mainly with reference to the structures that differ from those of the first embodiment. To simplify matters, the same index numbers from the first embodiment will be used for corresponding structures in the third embodiment.

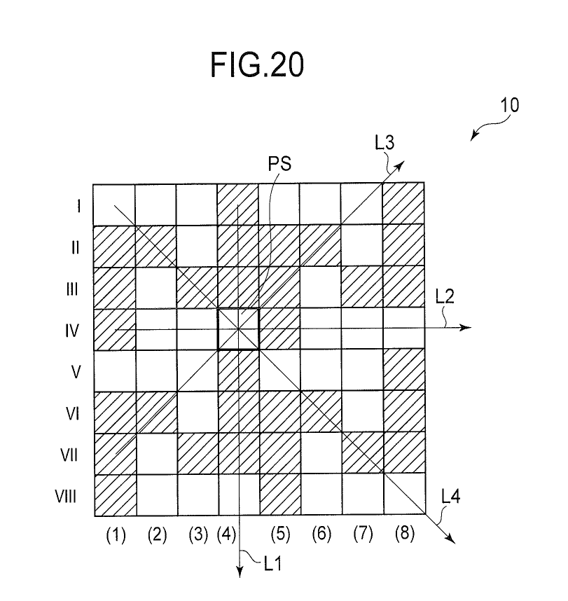

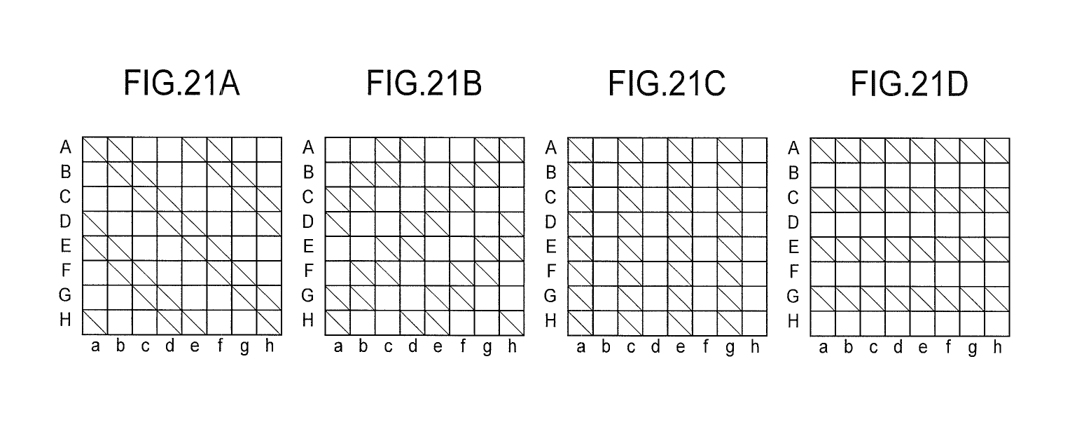

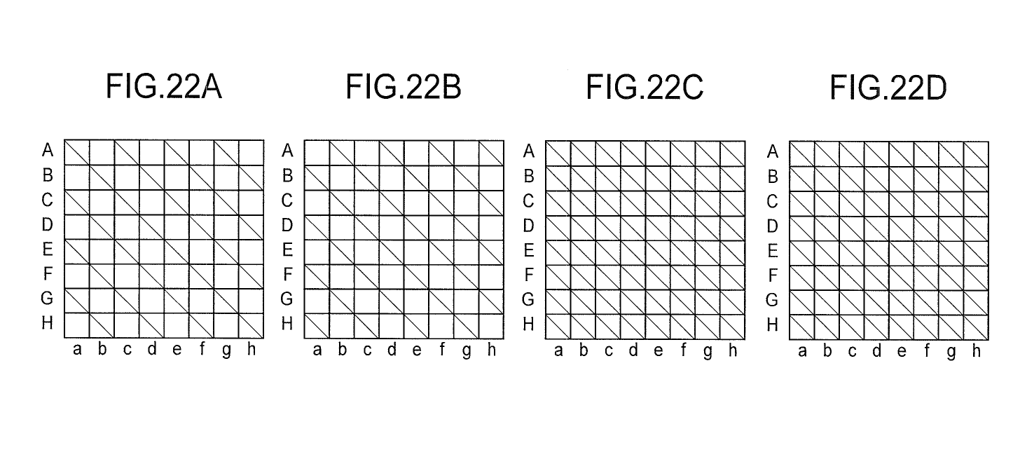

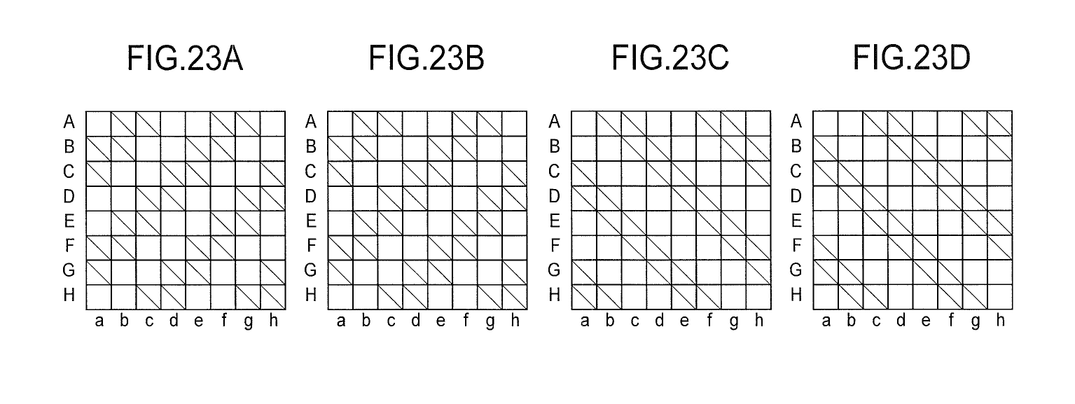

FIG. 20 is a pixel deployment diagram showing the arrangement of pixels on the image sensor 10 in the third embodiment. FIG. 21 is an e-r-difference diagram mapping the e-r-difference between each of pixels and a neighboring pixel in the third embodiment. FIG. 22 is an e-r-difference diagram mapping the e-r-difference between each of the pixels and a first next-neighboring pixel in the third embodiment. FIG. 23 is an e-r-difference diagram mapping the e-r-difference between each of pixels and a second next-neighboring pixel in the third embodiment.

FIG. 21A maps the e-r-differences between pixel pairs including a target pixel and a neighboring pixel arranged one row below the target pixel; FIG. 21B maps the e-r-differences between pixel pairs including a target pixel and a neighboring pixel arranged one column to the right of the target pixel; FIG. 21 C maps the e-r-differences between pixel pairs including a target pixel and a neighboring pixel arranged one row above and one column to the right of the target pixel; and FIG. 21D maps the e-r-differences between pixel pairs including a target pixel and a neighboring pixel arranged one row below and one column to the right of the target pixel.

As shown in FIGS. 21A to 21D, among the pixel pairs comprising a target pixel and a neighboring pixel arranged in any direction from the target pixels, the number of pixel pairs having the e-r-difference is equal to the number of pixel pairs having the same external reflected OPL.

FIG. 22A maps the e-r-differences between pixel pairs including a target pixel and a first next-neighboring pixel arranged two rows below the target pixel; FIG. 22B maps the e-r-differences between pixel pairs including a target pixel and a first next-neighboring pixel arranged in two columns right of the target pixel; FIG. 22C maps the e-r-differences between pixel pairs including a target pixel and a first next-neighboring pixel arranged two rows above and two columns to the right of the target pixel; and FIG. 22D maps the e-r-differences between pixel pairs including a target pixel and a first next-neighboring pixel arranged two rows below and two columns to the right of the target pixel.

As shown in FIGS. 22A and 22B, among the pixel pairs comprising a target pixel and a first next-neighboring pixel arranged two rows below and two columns to the right of the target pixels, the number of pixel pairs having the e-r-difference is equal to the number of pixel pairs having the same external reflected OPL.

On the other hand, as shown in FIGS. 22C and 22D, among pixel pairs comprising a target pixel and first next-neighboring pixel arranged two rows above and two columns to the right of the target pixel or two rows below and two columns to the right from the target pixels, all pixel pairs have the e-r-differences.

Accordingly, in the third embodiment, among pixel pairs comprising a target pixel and a first next-neighboring pixel arranged in any directions from the target pixels, the ratio of pixel pairs having the e-r-difference to all pixel pairs is 75%, and the ratio of pixel pairs having the same external reflected OPL to all pixel pairs is 25%.

FIG. 23A maps the e-r-differences between pixel pairs including a target pixel and a second next-neighboring pixel in the same arrangement as FIG. 15A; FIG. 23B maps the e-r-differences between pixel pairs including a target pixel and a second next-neighboring pixel in the same arrangement as FIG. 15B; FIG. 23C maps the e-r-differences between pixel pairs including a target pixel and a second next-neighboring pixel in the same arrangement as FIG. 15C; and FIG. 23D maps the e-r-differences between pixel pairs including a target pixel and a second next-neighboring pixel in the same arrangement as FIG. 15D.

As shown in FIGS. 23A to 23D, among the pixel pairs comprising a target pixel and a second next-neighboring pixel arranged in any direction from the target pixel, the number of pixel pairs having the e-r-difference is equal to the number of pixel pairs having the same external reflected OPLs.

In the above third embodiment, the number of pixel pairs having the e-r-differences of (m+1/2)×λ and comprising a target pixels and either a neighboring pixel, or second next-neighboring pixel in any direction from the target pixel is equal to the number of pixel pairs having the same external reflected OPL. However, the number of pixel pairs having e-r-differences and comprising a target pixel and a first next-neighboring pixel in any direction from the target pixel in the third embodiment is greater than the number in the second embodiment.

In the above third embodiment, the contrast of the diffraction light based on the reflection at the external surface of the micro-lens array 16 can be reduced by rearranging the pixel pairs with the e-r-difference of (m+1/2)×λ between the pair. By reducing the contrast of the diffraction light, the influence of the r-d-ghost image can be mitigated.

The third embodiment is different from the first embodiment, in that the number of pixel pairs having the e-r-difference among all of the pixel pairs comprising a target pixel and a first next-neighboring pixel is greater than the number of pixel pairs having the same external reflected OPL. And the ratio of the pixel pairs having the e-r-difference to all pixel pairs is greater than that in the second embodiment. Accordingly, the effect from reducing the influence of the r-d-ghost image in the third embodiment is less those in the first and second embodiments. However, the influence of the r-d-ghost image can be sufficiently reduced in comparison to an image sensor having pixels of with equal external reflected OPLs.

Next, an image sensor of the fourth embodiment is explained. The primary difference between the fourth embodiment and the first embodiment is the arrangement of normal pixels and lengthened pixels. The fourth embodiment is explained mainly with reference to the structures that differ from those of the first embodiment. To simplify matters, the same index numbers from the first embodiment will be used for corresponding structures in the fourth embodiment.

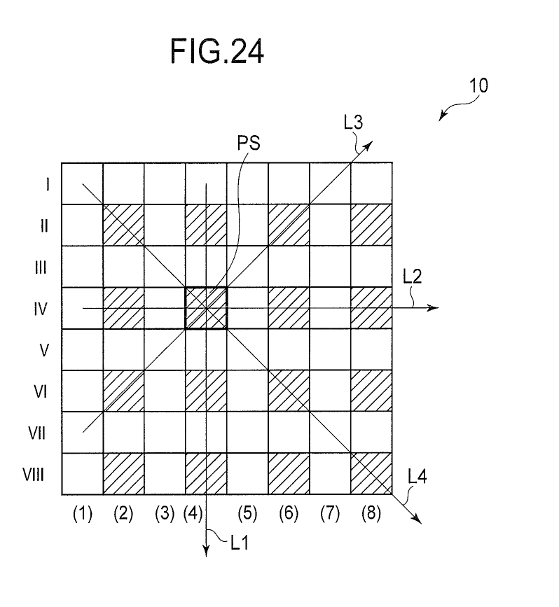

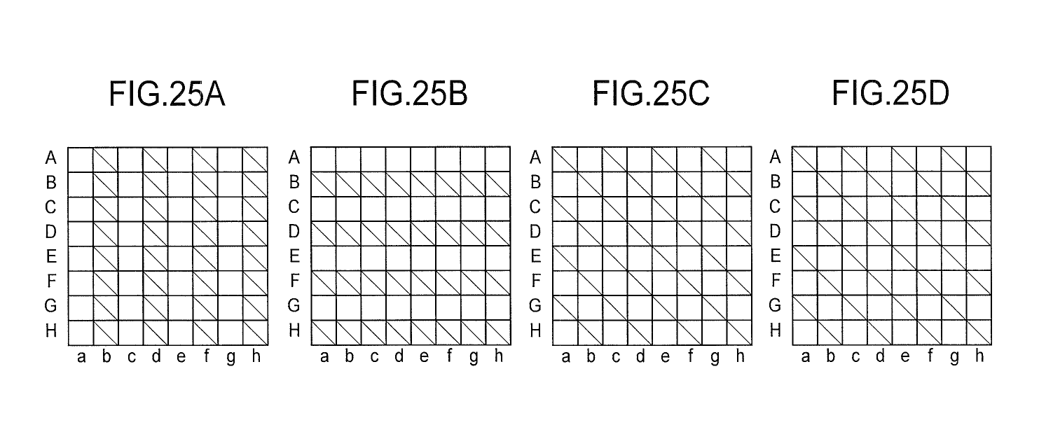

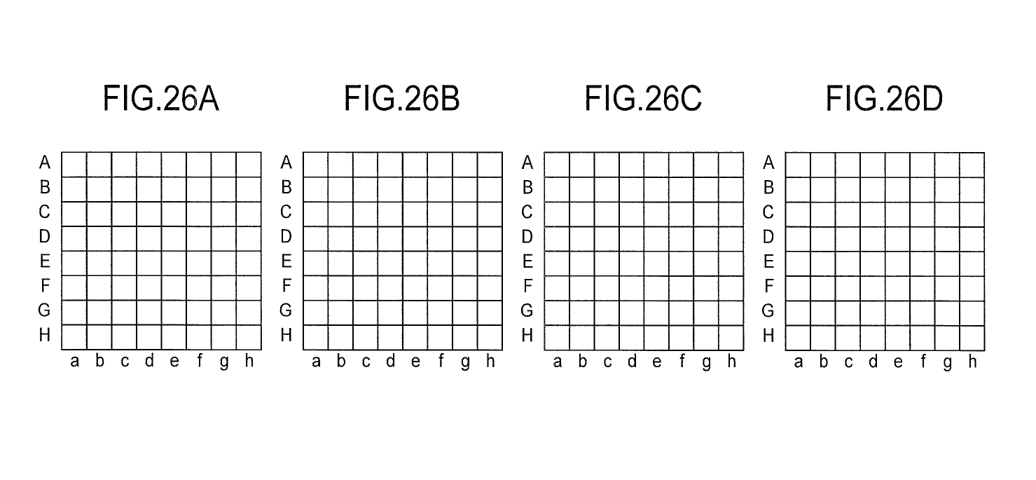

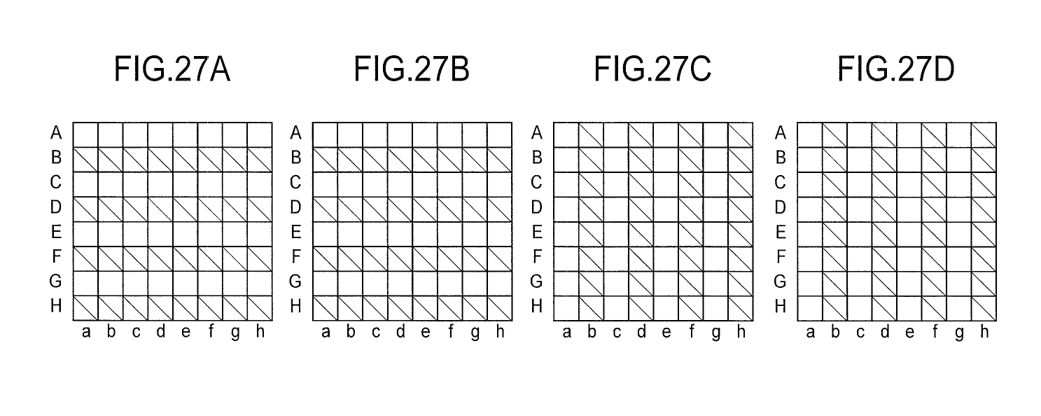

FIG. 24 is a pixel deployment diagram showing the arrangement of pixels on the image sensor 10 in the fourth embodiment. FIG. 25 is an e-r-difference diagram mapping the e-r-difference between each of pixels and a neighboring pixel in the fourth embodiment. FIG. 26 is an e-r-difference diagram mapping the e-r-difference between each of pixels and a first next-neighboring pixel in the fourth embodiment. FIG. 27 is an e-r-difference diagram mapping the e-r-difference between each of pixels and a second next-neighboring pixel in the fourth embodiment.

FIG. 25A maps the e-r-differences between pixel pairs including a target pixel and a neighboring pixel arranged one row below the target pixel; FIG. 25B maps the e-r-differences between pixel pairs including a target pixel and a neighboring pixel arranged one column to the right of the target pixel; FIG. 25C maps the e-r-difference between pixel pairs including a target pixel and a neighboring pixel arranged one row above and one column to the right of the target pixel; and FIG. 25D maps the e-r-differences between pixel pairs including a target pixel and a neighboring pixel arranged one row below and one column to the right of the target pixel.

As shown in FIGS. 25A to 25D, among the pixel pairs comprising a target pixel and a neighboring pixel arranged in any direction from the target pixel, the number of pixel pairs having the e-r-difference is equal to the number of pixel pairs having the same external reflected OPL.

FIG. 26A maps the e-r-difference between pixel pairs including a target pixel and a first next-neighboring pixel arranged two rows below the target pixel; FIG. 26B maps the e-r-differences between pixel pairs including a target pixel and a first next-neighboring pixel arranged two columns to the right of the target pixel; FIG. 26C maps the e-r-differences between pixel pairs including a target pixel and a first next-neighboring pixel arranged two rows above and two columns to the right of the target pixel; and FIG. 26D maps the in-r-differences between pixel pairs including a target pixel and a first next-neighboring pixel arranged two rows below and two columns to the right of the target pixel.

As shown in FIGS. 26A to 26D, among the pixel pairs comprising a target pixel and a first next-neighboring pixel arranged in all directions from the target pixels, all pixel pairs have the same external reflected OPLs.

FIG. 27A maps the e-r-difference between pixel pairs including a target pixel and a second next-neighboring pixel in the same arrangement as FIG. 15A; FIG. 27B maps the e-r-differences between pixel pairs including a target pixel and a second next-neighboring pixel in the same arrangement as FIG. 15B; FIG. 27C maps the e-r-differences between pixel pairs including a target pixel and a second next-neighboring pixel in the same arrangement as FIG. 15C; and FIG. 27D maps the e-r-differences between pixel pairs including a target pixel and a second next-neighboring pixel in the same arrangement as FIG. 15D.

As shown in FIGS. 27A to 27D, among the pixel pairs comprising a target pixel and a second next-neighboring pixel arranged in any direction from the target pixels, the number of pixel pairs having the e-r-difference is equal to the number of pixel pairs having the same external reflected OPL.

In the above fourth embodiment, the contrast of the diffraction light based on the reflection at the external surface of the micro-lens array 16 can be reduced by rearranging the pixel pairs with the e-r-difference of (m+1/2)×λ between the pair. By reducing the contrast of the diffraction light, the influence of the r-d-ghost image can be mitigated.

The fourth embodiment is different from the first embodiment, in that all pixel pairs have the same external reflected OPL among pixel pairs comprising a target pixel and a first next-neighboring pixel. Accordingly, the effect from reducing the influence of the r-d-ghost image in the fourth embodiment is less than those in the first to third embodiments. However, the influence of the r-d-ghost image can be sufficiently reduced in comparison to an image sensor having pixels with equal external reflected OPLs.

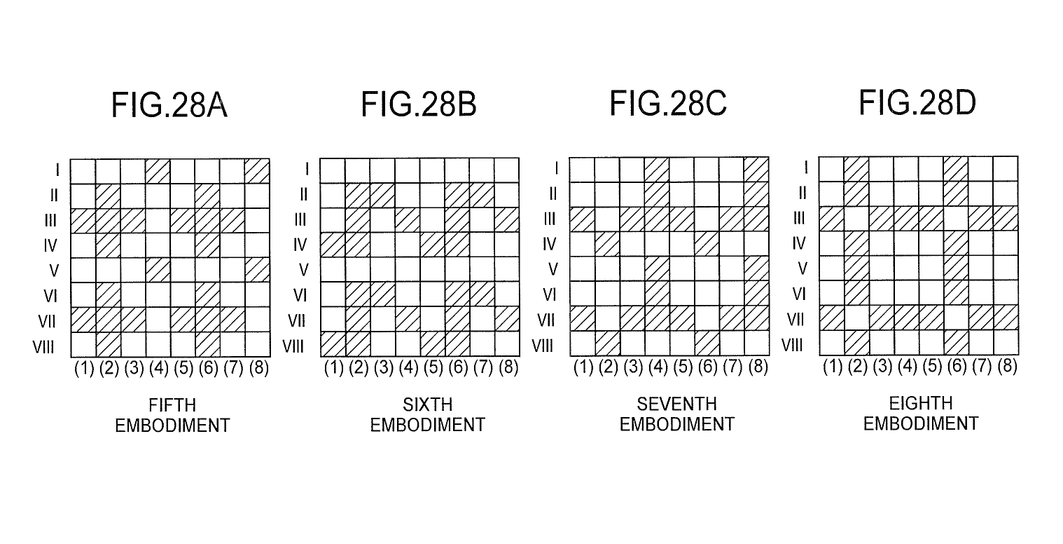

Next, image sensors of the fifth to eighth embodiments are explained. In the fifth to eighth embodiments, the arrangement of the lengthened pixels and the normal pixels is different from the arrangement in the first embodiment, as shown in FIG. 28. However, in the fifth to eighth embodiments, the number of pixel pairs comprising target pixels and either neighboring pixels, first next-neighboring pixels, or second next-neighboring pixels for all directions and having the e-r-differences is equal to the number of pixel pairs having the same external reflected OPL, similar to the first embodiment. Accordingly, the r-d-ghost image can be reduced in the fifth to eighth embodiments, similar to the first embodiment.

Next, an image sensor of the ninth embodiment is explained. FIG. 11 is a sectional view of the image sensor of the ninth embodiment.

The primary difference between the ninth embodiment and the first embodiment is the method for calculating the e-r-difference between a pair of pixels. The ninth embodiment is explained mainly with reference to the structures that differ from those of the first embodiment. Here, the same index numbers are used for the structures that correspond to those of the first embodiment.

In the ninth embodiment, the thickness of the micro lenses is constant. So, there is no difference between the distance from the light-receiving area of the photoelectric conversion layer 12 to the external or internal surface 16A, 16B of the micro-lens array 16. Optical elements that cause the external OPL to vary for each pixel are mounted above the external surface 16A of the micro-lens array 16.

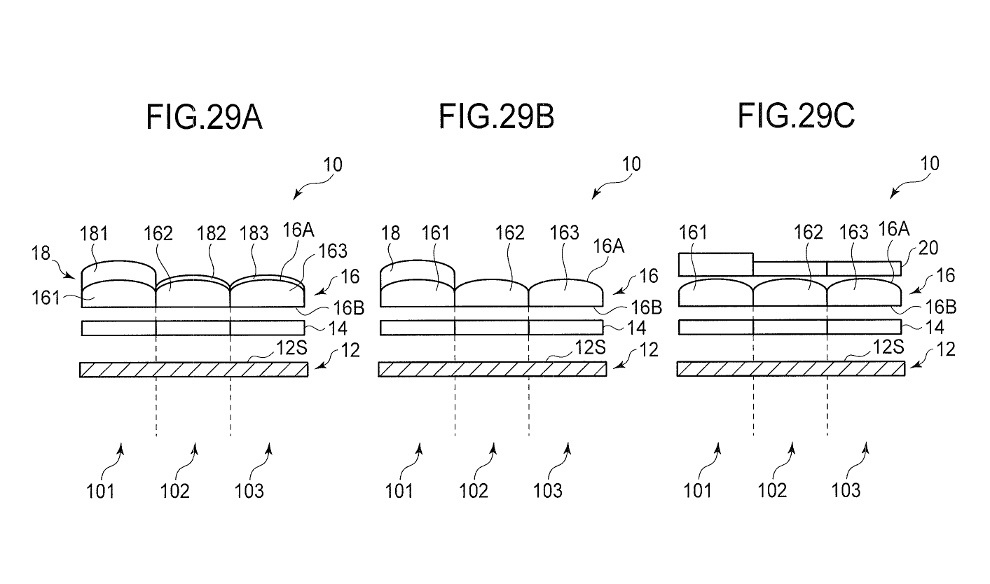

For example, as shown in FIG. 29A, a permeable film 18 is coated on the micro-lens array 16. The film 18 is formed so that the thickness varies across each of the pixels, such as the first-third area 181-183 corresponding to the first-third pixels 101-103. In addition, the film is coated so that the film makes contact with the micro-lens array 16. The e-r-difference between pairs of pixels can be produced by adding the film 18. In this case, the incident end of the incident light is the external surface of the film 18.

Further, as shown in FIG. 29B, the e-r-difference between pairs of pixels may be created by alternating pixels that have the film 18 with pixels that do not have the film 18. Moreover, the optical elements that cause the external OPL to change for each of the pixels are not limited to the film 18. As shown in FIG. 29C, a plate 20 made from resin or glass with varying thickness across each of the pixels can be used. In the above ninth embodiments, the effect of reducing the influence of the r-d-ghost image can be achieved by adding the above optical elements to general image sensors that are already in use or that have already been manufactured but are not yet in use.

In the above ninth embodiment, the e-r-differences can be created between pixel pairs by the optical element, such as the film 18 and the plate as described above. Accordingly, the influence of the r-d-ghost image can be mitigated by reducing the contrast of the diffraction light, similar to the first embodiment.

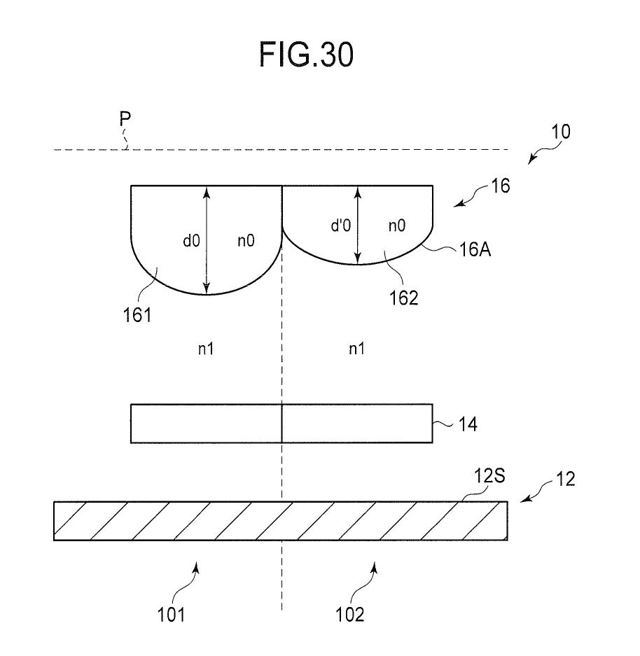

Next, an image sensor of the tenth embodiment is explained. The primary difference between the tenth embodiment and the first embodiment is the structure of the micro-lens array. The tenth embodiment is explained mainly with reference to the structures that differ from those of the first embodiment. Here, the same index numbers are used for the structures that correspond to those of the first embodiment. FIG. 30 is a sectional view of the image sensor of the tenth embodiment.

In the tenth embodiment, the micro-lens array 16 is mounted so that the external surface 16A of the micro-lens array 16 in the first embodiment faces the light-receiving area of the photoelectric conversion layer 12. In other words, the micro-lens array 16 in the first embodiment is inverted in the third embodiment. Accordingly, in the third embodiment, the entire external surface of the micro-lens array is a flat plane. Convex surfaces that work as micro lenses are mounted on the internal surface of the micro lens array 16.

Because the external surface of the micro-lens array 16 in the tenth embodiment is entirely flat, the diffraction light is not generated by reflection of light at the external surface. Accordingly, the diffraction light based on reflection is generated only at the internal surface. As described above, the i-r-difference is calculated as (d0−d′0)×n1×2 (n1 being the refractive index of the micro-lens array). In addition, the i-r-difference, which mitigates the influence of the i-d-ghost image, is (m+1/2)×λ (m being an integer). Accordingly, the difference between the thicknesses of micro lenses in a pair of pixels that is necessary to produce a phase difference is calculated as (m+1/2)×λ/((the refractive index of the micro lens)×2).

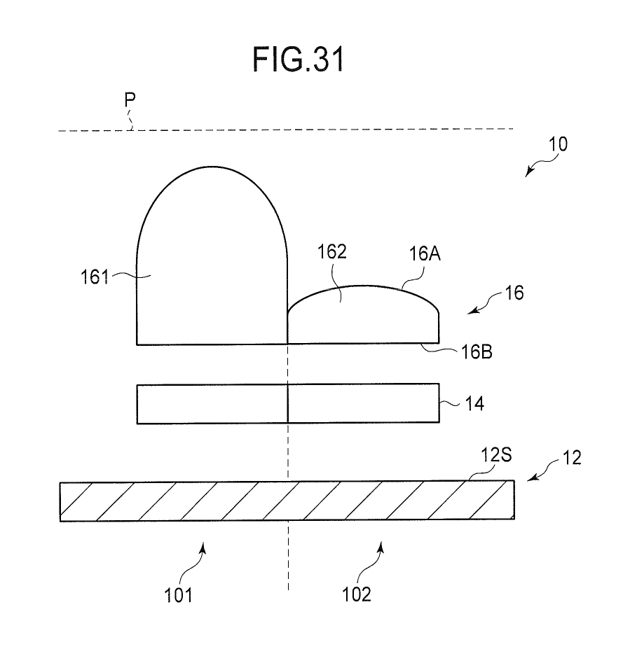

Next, an image sensor of the eleventh embodiment is explained. The primary difference between the eleventh embodiment and the first embodiment is the structure of the micro-lens array. The eleventh embodiment is explained mainly with reference to the structures that differ from those of the first embodiment. Here, the same index numbers are used for the structures that correspond to those of the first embodiment. FIG. 31 is a sectional view of the image sensor of the eleventh embodiment.

In the eleventh embodiment, the micro-lens array is formed in consideration of the diffraction light derived not only from reflection at the external surface but also from reflection at the internal surface. In other words, the micro-lens array is formed so that the e-r-difference and the i-r-difference are (m+1/2)×λ.

Similar to the first embodiment, the e-r-difference is (d′0−d0)×n0×2. Using the equation of d1+d0=d′1+d′0, the e-r-difference is (d1−d′1)×n0×2. Accordingly, the difference in thickness between pairs of adjacent micro lenses (d1−d′1) is calculated as (m1+1/2)×λ/(n0×2) (m1 being an integer) so that the phase difference of the light reflected at the external surfaces between the pixels having the micro lenses is one-half of the wavelength.

Similar to the first embodiment, the i-r-difference is (d1−d′1)×(n1−n0)×2. Accordingly, the difference in thickness between pairs of adjacent micro lenses (d1−d′1) is calculated as (m2+1/2)×λ/((n1−n0)×2) (m2 being an integer) so that the phase difference of the light reflected at the internal surfaces between the pixels having the micro lenses is one-half of the wavelength.

Accordingly, in order to shift the phase of the light reflected at external and internal surfaces between the pixels by one-half wavelength, the micro-lens array should be formed so that the difference in thickness between the pairs of micro lenses (d1−d′1) is equal to both (m1+1/2)×λ/(n0×2) and (m2+1/2)×λ/((n1−n0)×2). In order to satisfy the above condition, the refractive index of the micro-lens array should satisfy the equation (m1+1/2)×λ/(n0×2)=(m2+1/2)×λ/((n1−n0)×2). For example, assuming that m1 and m2 are 1 and 0, respectively, the refractive index of the micro-lens array is calculated to be 1.33.

By making the micro-lens array 16 from a substance of which the refractive index is 1.33 so that the i-r-difference is λ/2, the difference between the thickness of the micro lenses becomes (3/2)×λ/2. Then, the Using the micro-lens array, phase differences of light reflected between the external and internal surfaces of micro lenses can be one-half of the wavelength. In order to achieve this effect, the desired refractive index of the micro-lens array is 1.33. However, the refractive index can be less than or equal to 1.4 or greater than or equal to 1.66.

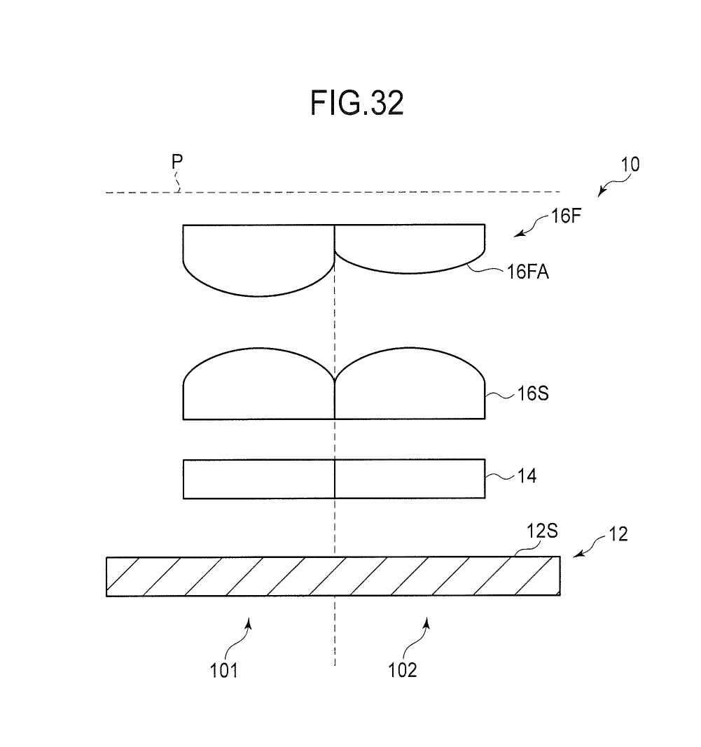

Next, an image sensor of the twelfth embodiment is explained. The primary difference between the twelfth embodiment and the first embodiment is the number of the micro-lens array mounted on the image sensor. The twelfth embodiment is explained mainly with reference to the structures that differ from those of the first embodiment. Here, the same index numbers are used for the structures that correspond to those of the first embodiment. FIG. 32 is a sectional view of the image sensor of the twelfth embodiment.

In the twelfth embodiment, a lens array system is composed of a plurality of micro-lens arrays, which are first and second micro lens arrays 16F, 16S. The first array 16F is mounted further from the photoelectric conversion layer 12 than the second micro-lens array 16S. One surface of the first micro-lens array 16F has differences in height between pixels, and the other surface is flat. The first micro-lens array 16F is configured so that the surface 16FA having a difference in height is an internal surface that faces the light-receiving area of the photoelectric conversion layer 12, so that the flat surface is the external surface.

For the first micro-lens array 16F, the difference in thickness between pixels can be created similar to the tenth embodiment. Accordingly, the i-r-difference between pixels in the twelfth embodiment is the same as that of the tenth embodiment.

Accordingly, the difference in thickness between pixels of the first micro-lens array 16F should be (m+1/2)×λ/((refraction index f of the micro-lens array)×2). For example, assuming that m and the refraction index are 1 and 1.5, respectively, the difference in thickness is calculated to be λ/2 (=(1+1/2)×λ/(1.5×2)).

The e-r-difference and i-r-difference for the reflection of the light at the external and internal surfaces of the second micro-lens array 16S are calculated to be λ/2 (=(difference in thickness between pixels of first micro-lens array 16F)×((refraction index of first micro-lens array 16F)−(refraction index of air))×2). Accordingly, the influence of diffraction light generated from the reflection of light at the external and internal surfaces of the second micro-lens array 16S can be mitigated.

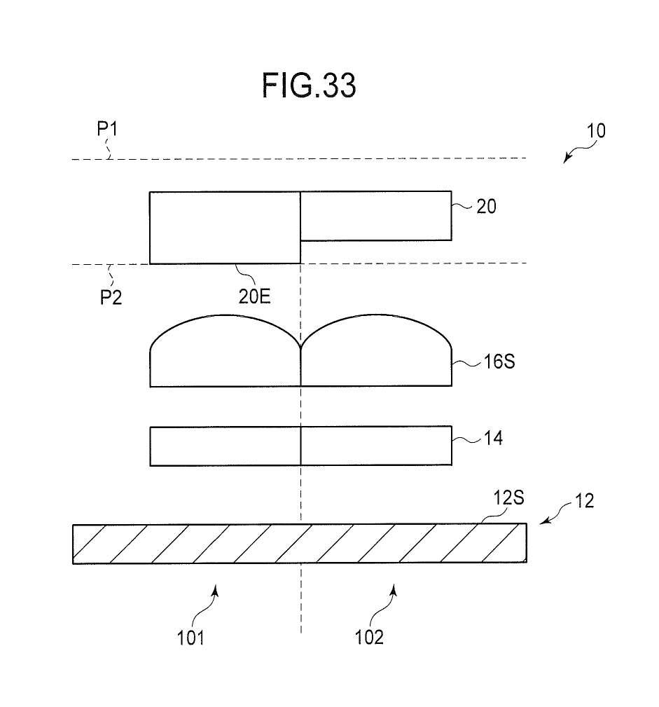

As shown in FIG. 33, instead of the first micro-lens array 16F, a phase plate 20 can be adopted so that the uneven surfaces face the light-receiving area of the photoelectric conversion layer 12. Or, the curvature of the micro lenses of the first micro-lens array 16F can be zero.

By cyclically creating the difference in the thickness between pixel areas of the phase plate 20, the e-r-difference and i-r-difference can be created. In addition, by making both surfaces of the phase plate 20 flat, the appearance of the r-d-ghost image generated by the reflection at the external and internal surfaces of the phase plate 20 can be prevented. In addition, it is preferable to reduce the reflectivity of the phase plate 20 by coating it with an agent.

The imagined plane described in the first embodiment is defined here as a first imagined plane (see “P1”). In addition, a plane that is parallel to the first imagined plane and a convex portion 20E of the internal surface of the phase plate 20 is defined as a second imagined plane.

When using the phase plate 20, the difference in OPLs from the first imagined plane to the external surface of the pixel's micro lenses and the difference in OPLs from the first imagined plane to the internal surface of the pixels' micro lenses are equal to the difference in the OPLs from the first imagined plane to the second imagined plane for pixels.

In addition, by cyclically creating the difference in the thickness between pixel areas of the phase plate 20, the difference in OPLs from the first imagined plane to any components mounted beneath the phase plate 20, such as the photoelectric converter layer 12, can also be created. The difference in the OPLs is equal to the difference in the OPLs from the first imagined plane to the second imagined plane for pixels, similar to the above.

In the above first to ninth embodiments, the influence of the r-d-ghost image generated by the reflection not only at the external surface but also at the internal surface can be reduced. By creating the difference in the distances from the photoelectric converter layer 12 to the internal surface 16B of the micro-lens array between pixels, the i-r-difference is created. Then, the r-d-ghost image generated by the reflection at the internal surface 16B can be reduced.

The i-r-difference can be created by creating the difference in thickness of micro lenses between two pixels. Owing to the i-r-difference, the influence of the r-d-ghost image generated by the reflection at the internal surface 16B of the micro-lens array 16 can be reduced. Or even if the difference in the thickness is not created, the i-r-difference can be created by changing at least one of the distances from the external and internal surfaces 16A, 16B to the photoelectric conversion layer 12.

In addition, the structure of the image sensor 10 is not limited to those in the above embodiments. For example, a monochrome image sensor can be adopted for the above embodiments.

In addition, for an image sensor where photoelectric converters that detect quantities of light having different wavelength bands, such as red, green, and blue light, are layered at all the pixels, the lengthened pixels and the normal pixels can be mixed and arranged similar to the above embodiments. Because it is common for the diffraction angle in such an image sensor to be greater than that for other types of image sensors, image quality can be greatly improved by mixing the arrangement of the lengthened pixels and normal pixels.

In this case, it is preferable that the e-r-difference or i-r-difference is determined according to the wavelength of whichever light can be detected by the photoelectric converter mounted at the deepest point from the incident end of the image sensor, such as the wavelength of red light. A light component that is reflected at the two photoelectric converters above the deepest one, which is red light in this case, generates more diffraction light than the other light components that are absorbed by the photoelectric converters above the deepest one.

In addition, the same effect can be achieved by attaching a micro-lens array having micro lenses of various thickness to the image sensor module, which does not have a micro-lens array having micro lenses of various thickness, as long as each pixel of the image sensor faces one micro lens. For example, the same effect can be achieved by attaching the micro-lens array to a manufactured image sensor. Similar to a micro-lens array, the same effect can be achieved by attaching a glass cover or optical low-pass filter of which thickness is different for each of the pixels.

The e-r-difference or i-r-difference is desired to be (m+1/2)×λ (m being an integer and λ being the wavelength of incident light) for the simplest pixel design. However, their differences are not limited to (m+1/2)×λ.

For example, the length added to the wavelength multiplied by an integer is not limited to half of the wavelength. One-half of the wavelength multiplied by a coefficient between 0.5 and 1.5 can be added to the product of the wavelength and an integer. Accordingly, the micro lens array can be formed so that the e-r-difference or i-r-difference is between (m+1/4)×λ and (m+3/4)×λ.

In addition, the micro-lens array can be formed so that the e-r-difference or i-r-difference is (m+1/2)×λb (where λb is between 0.5λc<λb<1.5λc and λc is a middle wavelength value of a band of light that reaches the photoelectric converter).

In addition, the micro-lens array can be formed so that the e-r-difference or i-r-difference is (m+1/2)×λb (where λb is between 0.5λe<λb<1.5λe and λe is a middle wavelength value of a band of light that passes through each of the color filters).

The wavelength band of the incident light that reaches the photoelectric conversion layer 12 includes visible light. Accordingly, assuming that λg is a wavelength near to the middle wavelength in the band of visible light, the e-r-difference, which is equal to the difference in the of thickness of the micro lens, is desired to be (m+1/2)×λg. For example, the e-r-difference is desired to be within 200 nm-350 nm, especially within 250 nm-300 nm. Instead of using λg, the wavelength near the middle wavelength for the band of each color of light that passes through each color filter can be used for the above calculation.

In addition, it is preferable that the number of pixel pair having the e-r-difference of (m+1/2)×λ is equal to the number of the pixel pairs with external reflected OPLs that are equal between the target pixel and either the neighboring pixel or the first or second next-neighboring pixel, as in the first embodiment.

However, even if the number of pixel pairs having the e-r-difference is different from the number of pixel pairs having the same external reflected OPLs, the influence of the r-d-ghost image can be sufficiently reduced compared to the image sensor in which all pixels have the same external reflected OPLs, as in the second to fourth embodiments.

### EXAMPLES

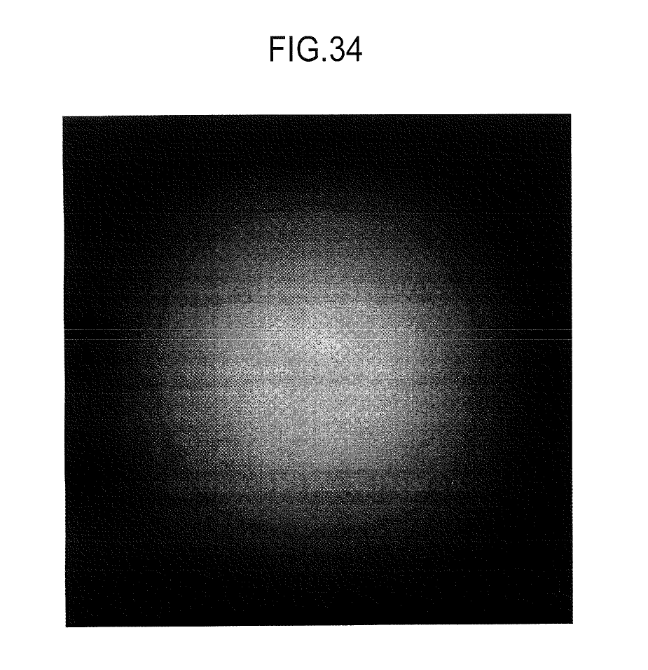

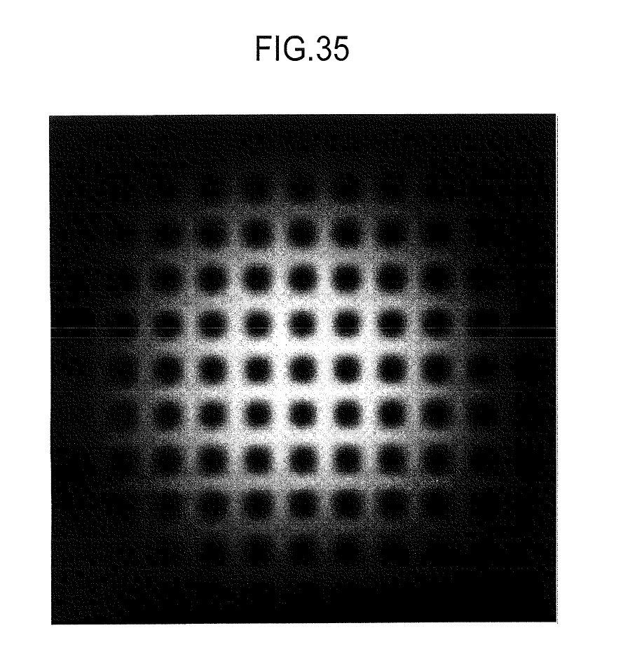

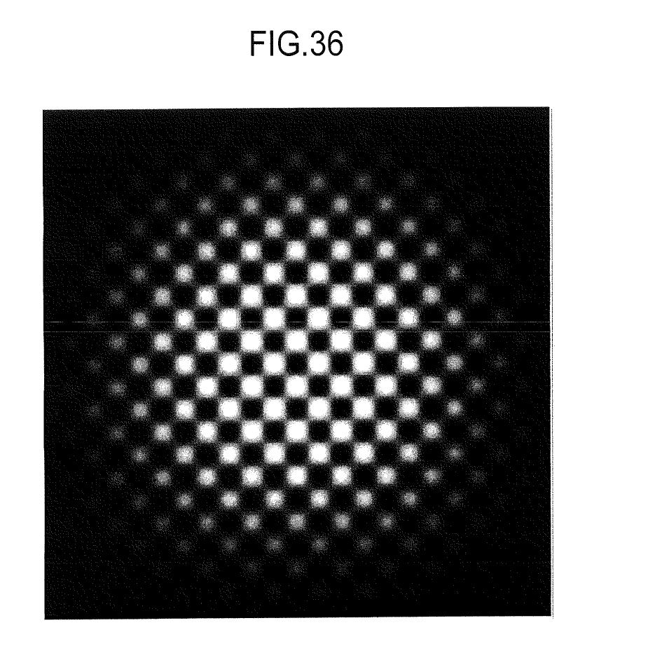

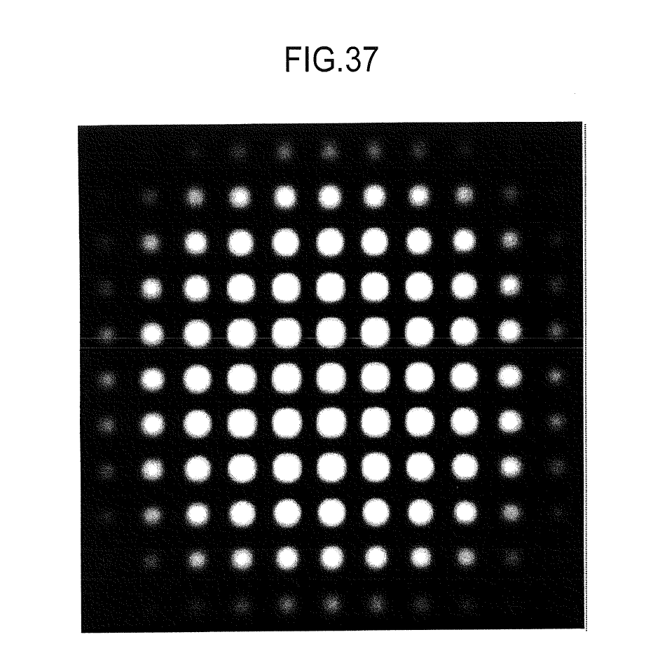

Next, this embodiment is explained with regard to the concrete arrangement of the lengthened pixels and the normal pixels and the effect below, with reference to following examples using FIGS. 34-38. However, this embodiment is not limited to these examples.

In the first to fourth examples, the lengthened pixels and the normal pixels were arranged as in the first to fourth embodiments, respectively. In addition, in the comparative example, the external reflected OPLs were the same for all pixels. Accordingly, phase differences were not created between all pixel pairs in the comparative example.

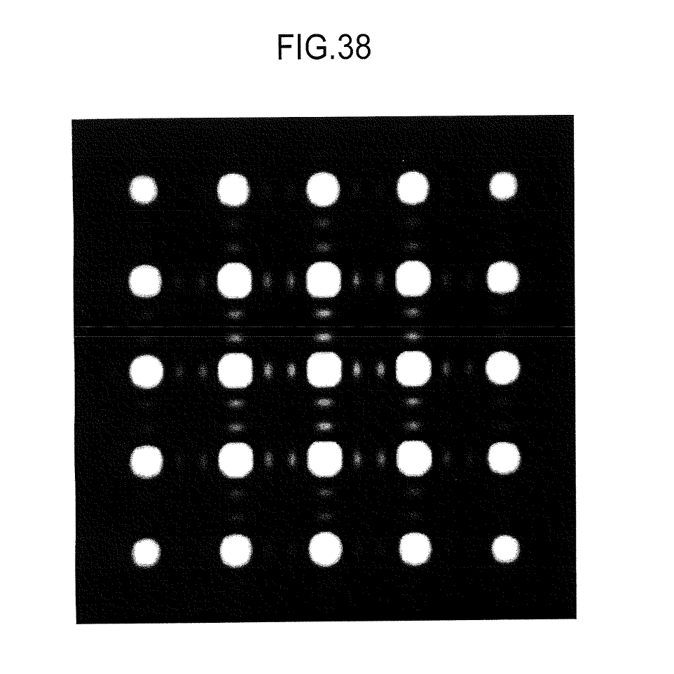

FIGS. 34-37 show the contrast of the diffraction light of the first to fourth examples, respectively. FIG. 38 shows the contrast of the diffraction light of the comparative example.

Under the assumption that the contrast of the diffraction light in the comparative example is 1, the relative contrast of the diffraction light in the above first to fourth examples has been calculated and presented in table 1.

TABLE 1

| | Relative Contrast |
|---|---|
| First Example | 0.004 |
| Second Example | 0.076 |
| Third Example | 0.139 |
| Fourth Example | 0.288 |
| Comparative Example | 1.000 |

As shown in FIGS. 34-38 and the above table 1, the contrast values in the first to fourth examples are much lower than the contrast in the comparative example. Accordingly, it is recognized that the contrast of the diffraction light can be reduced sufficiently by rearranging the lengthened and normal pixels, as in the first to fourth examples.

It is estimated that a diffraction angle of one-half the diffraction angle of the comparative example would be obtained by changing the directions of some parts of the diffraction light, thereby reducing the contrast of the full quantity of diffraction light. It is also estimated that the variation of the diffraction angle of the diffraction light generated between a target pixel and a neighboring pixel contributes to the reduction in contrast because the neighboring pixel is nearest to the target pixel.

As shown in FIGS. 34-37 and in Table 1, the contrast is lowest for the first embodiment and increases in order for the second, third, and fourth embodiments.

Out of all pixels, the percentages of pixel pairs having the e-r-difference between a target pixel and a first next-neighboring pixel are 50%, 63%, 75%, and 0% in the first, second, third, and fourth examples, respectively. The absolute values of the differences between the above percentages and 50% are 0%, 13%, 25%, and 50%, respectively. Accordingly, it is recognized that the contrast can be reduced by a proportionately greater amount as the ratio of pixel pairs with the e-r-differences comprising a target pixel and a first next-neighboring pixel to all pixels approaches 50%.

The interference of the diffraction light appears not only between a target pixel and a neighboring pixel but also between a target pixel and a next-neighboring pixel. Accordingly, it is estimated that the contrast can be reduced by a proportionately greater amount as the ratio of pixel pairs with the e-r-differences comprising a target pixel and a next-neighboring pixel to all pixels approaches 50%.

However, a sufficient reduction in contrast was confirmed in the above examples. Accordingly, it is recognized that the contrast can be reduced as long as pixel pairs comprising a target pixel and a first next-neighboring pixel are mixed between those having the same e-r-differences and those having the same external reflected OPLs. In addition, it is clear from the above examples that the contrast can be sufficiently reduced, at minimum, by mixing the pixel pairs comprising a target pixel and either first or second next-neighboring pixel that have the e-r-differences so that the ratio of the pixel pairs having the e-r-differences to all pixels is between 25%-75%.

Although the embodiments of the present invention have been described herein with reference to the accompanying drawings, obviously many modifications and changes may be made by those skilled in this art without departing from the scope of the invention.

The present disclosure relates to subject matters contained in Japanese Patent Applications No. 2009-157236 (filed on Jul. 1, 2009) and No. 2010-144156 (filed on Jun. 24, 2010), which are expressly incorporated herein, by references, in their entireties.

1. An image sensor comprising a plurality of pixels that comprises photoelectric converters and optical members, the optical member covering the photoelectric converter, incident light passing through the optical member, the pixels being arranged in two dimensions on a light-receiving area,
first differences being created for the distances between the photoelectric converter and a far-side surface of the optical member in two of the pixels in a portion of pixel pairs among all of the pixel pairs, the far-side surface being an opposite surface of a near-side surface, the near-side surface of the optical member facing the photoelectric converter, the pixel pair including two of the pixels selected from the plurality of pixels.

2. An image sensor according to claim 1, wherein two pixels with the first difference between them have optical members with different thicknesses.

3. An image sensor comprising a plurality of pixels that comprises photoelectric converters and optical members, the optical member covering the photoelectric converter, light toward the photoelectric converters passing through the optical member, the pixels being arranged in two dimensions on a light-receiving area,
first differences being created in the thickness of the optical member between two of the pixels in a portion of pixel pairs among all of the pixel pairs, the pixel pair including two pixels selected from the plurality of pixels.

4. An image sensor according to claim 3, wherein the distances between the photoelectric converter and a far-side surface of the optical member are equal for two pixels with the first difference between them.

5. An image sensor according to claim 1, wherein the pixel pairs having the first difference are cyclically arranged in a predetermined direction on the light-receiving area.

6. An image sensor according to claim 5, wherein the pixel pairs having the first difference are cyclically arranged in a minimum of first and second directions on the light-receiving area.

7. An image sensor according to claim 1, wherein the number of the pixel pairs having the first difference is substantially equal to the number of pixel pairs that do not have the first difference.

8. An image sensor according to claim 7, wherein the pixel pair is a pair of a target pixel and neighboring pixel arranged in at least one direction from the target pixel, the target pixel is the pixel selected one-by-one among the plurality of pixels, the neighboring pixels are the eight pixels positioned nearest to the target pixel in eight different directions.

9. An image sensor according to claim 7, wherein the pixel pair is a pair of a target pixel and a next-neighboring pixel arranged in at least one direction from the target pixel, the target pixel is the pixel selected one-by-one among the plurality of pixels, the next-neighboring pixels are the 16 pixels positioned nearest to and surrounding the eight neighboring pixels, the neighboring pixels are the eight pixels positioned nearest to the target pixel in eight different directions.

10. An image sensor according to claim 7, wherein,
the number of pixel pairs having the first difference is substantially equal to the number of pixel pairs in a pixel unit, the pixel pair is a pair of a first target pixel and pixel nearest to the target pixel in a predetermined direction, the pixel unit includes 16 of the pixels arranged along four first lines and four second lines, the target pixel is the pixel selected one-by-one among the plurality of pixels, the first and second lines are perpendicular to each other,
a plurality of pixel units are mounted on the image sensor.

11. An image sensor according to claim 1, wherein the pixel comprises a color filter, the first difference is determined so that the phase difference is created for light passing through the color filters and being reflected by the photoelectric converters of both pixels in the pixel pairs.

12. An image sensor according to claim 1, wherein the optical member is a micro lens.

13. An image sensor according to claim 1, wherein the pixel comprises a micro lens mounted between the photoelectric converter and the optical member.

14. An image sensor according to claim 1, wherein the first difference is greater than ((m1+1/4)×λ)/2 and less than ((m1+3/4)×λ)/2, m1 is an integer, λ is the middle value of a wavelength band of light that is assumed to be made incident on the photoelectric converter.

15. An image sensor according to claim 3, wherein the first difference is greater than ((m1+1/4)×2)/((n1−n2)×2) and less than ((m1+3/4)×2)/((n1−n2)×2), m1 is an integer, λ is the middle value of a wavelength band of light that is assumed to be made incident on the photoelectric converter, n1 is a refractive index of the optical member, n2 is the refractive index of air or the refractive index of a substance filled in a space that creates the first distance.

16. An image sensor according to claim 1, wherein the first difference is greater than ((m2+1/2)×λ)/4 and less than ((m2+1/2)×λ)/(3/4), m2 is an integer, λ, is the middle value of a wavelength band of light that is assumed to be made incident on the photoelectric converter.

17. An image sensor according to claim 3, wherein the first difference is greater than ((m2+1/2)×λ)/((n1−n2)×4) and less than ((m2+1/2)×2)/((n1−n2)×(3/4)), m2 is an integer, λ, is the middle value of a wavelength band of light that is assumed to be made incident on the photoelectric converter, n1 is a refractive index of the optical member, n2 is the refractive index of air or the refractive index of a substance filled in a space that creates the first distance.

18. An image sensor according to claim 1, wherein the first difference is between 100 nm and 175 nm.

19. An image sensor according to claim 1, wherein the first difference is between 125 nm and 150 nm.

20. An image sensor according to claim 3, wherein a first value is between 100 nm and 175 nm, the first value is the first difference divided by (n1−n2), n1 is a refractive index of the optical member, n2 is the refractive index of air or the refractive index of a substance filled in a space that creates the first distance.

21. An image sensor according to claim 20, wherein the first value is between 125 nm and 150 nm.

22. An image sensor comprising a plurality of pixels that comprises photoelectric converters and optical members, the optical member covering the photoelectric converter, incident light passing through the optical member, the pixels being arranged in two dimensions on a light-receiving area,
first differences being created for the distances between the photoelectric converter and a near-side surface of the optical member in both of the pixels in a portion of pixel pairs among all of the pixel pairs, the near-side surface of the optical member facing the photoelectric converter, the pixel pair including two pixels selected from the plurality of pixels.
